(19) United States
(12) Patent Application Publication
(10) Pub. No.: US 2025/0265166 A1
(43) Pub. Date: Aug. 21, 2025

(54) AGGREGATED SOFTWARE UPDATE RING DEPLOYMENT IN MANAGED NETWORKS

(71) Applicant: Ivanti, Inc., South Jordan, UT (US)

(72) Inventors: Matthew Hazzard, New Brighton, MN (US); Mitch Berg, Saint Paul, MN (US)

(73) Assignee: Ivanti, Inc., South Jordan, UT (US)

(21) Appl. No.: 19/058,680

(22) Filed: Feb. 20, 2025

Related U.S. Application Data
(60) Provisional application No. 63/555,831, filed on Feb. 20, 2024.

(51) Int. Cl. G06F 11/32; G06F 8/65

(52) U.S. Cl. CPC G06F 11/324; G06F 8/65

(57) ABSTRACT

A method of automated software management may includereceiving a first status communication from a first endpoint device. The first status communication may include a first patch identifier and a first status time for the first endpoint device in which the first patch identifier is associated with a first patch. The method may include receiving a second status communication from a second endpoint device. The second status communication may include a second patch identifier associated with a second patch and a second status time for the second endpoint device. The method may include computing visualization data based on a selected time duration in which the visualization data may include the first patch identifier, the second patch identifier, and a first ring group identifier.

### CROSS REFERENCE TO RELATED APPLICATION

This application claims the benefit of and priority to U.S. Provisional Application No. 63/555,831, filed Feb. 20, 2024, which is incorporated herein by reference in its entirety.

### FIELD

The examples described in this disclosure are related to automated endpoint product management, and in particular to product management using aggregated software update ring deployment.

### BACKGROUND

In enterprise and other managed networks, an endpoint refers to a computing device that is integrated into the network and that is in communication with a management device. The management device may include a server device, for instance, that has visibility to operating parameters and state parameters of the endpoints. Based on information communicated between the management device and the endpoints, the management device may detect issues at the endpoints, deploy solutions to the endpoints, update software on the endpoints, troubleshoot issues at the endpoints, provision roles and security controls to the endpoints, etc.

One element of the managed networks is coordination and distribution of product updates. Sometimes this operation is referred to as patch management. The updates or patches generally include code changes to products on the managed endpoints or some subset thereof. The products that are updated include software applications, software tools, operating systems, and the like. Distribution of the updates is used to ensure the products are properly functioning and to ensure cybersecurity vulnerabilities are addressed.

In some circumstances, a vendor publicizes the updates that are relevant to its products. Publication of the updates is an ongoing process. For instance, MICROSOFT® has traditionally released software patches on “Patch Tuesday” which occurs on the second and sometimes the fourth Tuesday of each month. In addition, software patches might be released and published responsive to detection of a specific vulnerability. Following publication of the software patches, administrators of the managed networks may access and distribute the product updates.

In these and other managed networks, it is difficult to properly and efficiently manage updates. Some products may persist in an un-patched or out-of-date state because the recommended product updates are not distributed. Additionally, product updates may not function as intended. Accordingly, product updates may not be distributed across an entire network all at once. Distribution of product updates at different times may be difficult to properly and efficiently manage. Additionally, storage and maintenance of the product updates may consume computing storage resources and computing processing resources. Accordingly, there is a need to improve the product update management systems and processes.

The subject matter claimed herein is not limited to examples that solve any disadvantages or that operate only in environments such as those described. Rather, this background is only provided to illustrate one example technology area where some examples described herein may be practiced.

### SUMMARY

According to an aspect of the invention, an embodiment includes a method of automated software management. The method may include receiving a first status communication from a first endpoint device. The first status communication includes a first patch identifier and a first status time for the first endpoint device. The first patch identifier is associated with a first patch. The method may include receiving a second status communication from a second endpoint device. The second status communication includes a second patch identifier associated with a second patch and a second status time for the second endpoint device. The method may include identifying a first ring group based on a first ring group identifier. The first ring group includes the first endpoint device and the second endpoint device. The method may include computing visualization data based on a selected time duration. The visualization data includes the first patch identifier, the second patch identifier, and the first ring group identifier. The method may include computing a first ring group visualization using the visualization data. The method may include filtering the visualization data based on the first ring group to generate a patch deployment visualization. The patch deployment visualization includes a patch deployment progress for the first patch in the first ring group and for a second patch in the first ring group. The method may include providing the first ring group visualization and the patch deployment visualization via a user interface.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Examples will be described and explained with additional specificity and detail through the use of the accompanying drawings in which:

FIG. 1 depicts a block diagram of an example operating environment in some examples described in the present disclosure that may be implemented;

FIG. 2 depicts a block diagram of an example aggregated software update ring deployment process that may be implemented in the operating environment of FIG. 1;

FIG. 3 depicts a timing diagram of an example aggregated software update ring deployment process that may be implemented in the operating environments of FIG. 1 and FIG. 2;

FIG. 4 depicts a flowchart of an example aggregated software update ring deployment process that may be implemented in the operating environments of FIG. 1 and FIG. 2;

FIG. 5A depicts a screenshot of an example user interface that may be implemented on a device implementing one or more of the processes of FIGS. 1 to 4;

FIG. 5B depicts a screenshot of an example user interface that may be implemented on a device implementing one or more of the processes of FIGS. 1 to 4;

FIG. 6 depicts a process flow of an example aggregated software update ring deployment process that may be implemented in the operating environment of FIG. 1 and FIG. 2;

FIG. 7 illustrates an example computer system operable for aggregated software update ring deployment; and

FIGS. 8A-8D are a flow chart of an example method of aggregated software update ring deployment, all according to at least one example described in the present disclosure.

### DESCRIPTION OF SOME EXAMPLE EMBODIMENTS

The examples described in this disclosure are related to automated endpoint product management. Some examples provide endpoint product management using aggregated software update ring deployment.

Product updates (e.g., patches) may not operate as intended without testing. Accordingly, patches may not be deployed across a network at one time. Instead, patches may be deployed across a managed network of endpoints using ring deployment. For instance, there may be a first ring which may include 1% of endpoints. If a patch is applied as intended in the first ring, then the patch may be applied across a second subset of device, e.g., in a second ring which may include a larger percentage of endpoints, such as 9%. If the patch applies as intended in the first ring and the second ring, then the patch may be widely deployed across the network (e.g., the remaining 90%). An installation in a next ring may be dependent on a success at an earlier ring.

With each deployment, there may be a “soak” period. This soak period is the period of time between communication of the command to implement the patch and when the patch is installed at the endpoint. The soak period may be any amount of time, including a very small amount of time (e.g., minutes), a few days, around 14 days, or any other amount of time. Accordingly, there may be a delay between an administrator approving the patch deployment and its installation across the network. Further, in a typical ring deployment scheme it may take a month for a patch to move through the rings (e.g., installed on most or all of the endpoints). This timing may cause issues because as a first patch is being deployed, another vulnerability may be discovered before it has been applied to all endpoints. This problem can be compounded when multiple patches are all being deployed in various ring deployment schemes at the same time. Therefore, managing multiple patches at different times may be difficult.

Even more technical problems exist in conventional patch management systems. For instance, in some conventional managed networks, product update or patch management are conducted without knowledge about aggregated patch deployment. Accordingly, in these conventional management systems, more than one patch may be deployed concurrently. For example, a second patch may be deployed in a first ring while a first patch is soaking or being deployed in a second ring. Managing the different patches at the device level may be difficult. Administrators monitor these patch deployments, which creates a high management overhead. In particular, there may be delays in initiating subsequent rings because the completion time for earlier rings may be unknown. Moreover, failures may occur at particular devices regarding multiple patches, which may not be seen and corrected.

Aspects of the present disclosure address these and other technical problems that exist in conventional patch management systems. For instance, in some networks, patches may be monitored at the device level. With this functionality, status communications may be received and aggregated according to patch, ring groups, and/or time. In the event of patch failures, the status communication may indicate a reason for failure (or may include data from which a potential cause of failure can be deduced or inferred), which is also organized and visible. Accordingly, at any time, an administrator may use the disclosed systems and methods to visualize a patch status across an entire network of endpoint devices and across each of the ring groups. This visualization may be provided via a graphical user interface (GUI). Moreover, the promotion or lack of promotion can be viewed, initiated, and/or corrected based on the results visualized by the GUI.

Moreover, the GUI may be used to control and administer software patch deployment based on the aggregated data. For example, instead of managing each patch as it is promoted through the rings, the present disclosure may aggregate patch data across endpoint devices, patch rings, and for more than one patch as the aggregated data, which may be provided and managed using a centralized management GUI. Example GUIs provided may enable manual promotion, device-troubleshooting, patch troubleshooting, rules-based automated promotion, pausing the deployment, etc.

In an example, each patch may be represented as a widget on a “patch assembly line” on the GUI. Using the GUI, the administrator can view the entire patch assembly line and determine the status of each patch using the widget on the assembly line at once. The GUI can be updated to show patch status per endpoint, patch, or at an aggregated level.

The present disclosure provides some examples that include systems and processes that may receive a first status communication from a first endpoint device. The first status communication may include a first patch identifier and a first status time for the first endpoint device. The first patch identifier may be associated with a first patch. The systems and processes may receive a second status communication from a second endpoint device. The second status communication may include a second patch identifier for a second patch and a second status time for the second endpoint device. The systems and processes may identify a first ring group based on a first ring group identifier. The first ring group may include the first endpoint device and the second endpoint device. The systems and processes may compute visualization data based on a selected time duration. The visualization data may include the first patch identifier, the second patch identifier, and the first ring group identifier. The systems and processes may compute a first ring group visualization using the visualization data. The systems and processes may filter the visualization data based on the first ring group to generate a patch deployment visualization. The patch deployment visualization may include a patch deployment progress for the first patch in the first ring group and for a second patch in the first ring group. The systems and processes may provide the first ring group visualization and the patch deployment visualization via a user interface.

These and other examples are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures is not intended to limit the scope of the systems and methods, as claimed, but is merely representative of example configurations of the systems and methods.

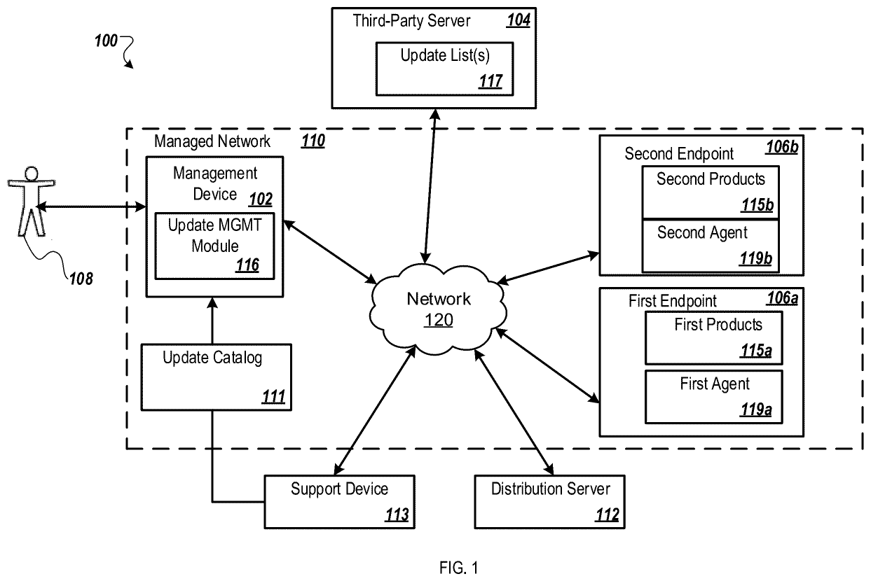

FIG. 1 is a block diagram of an example operating environment 100 in which some examples of the present disclosure can be implemented. The operating environment 100 may be configured for implementation of product update management in a managed network 110. The product update management may enable product updates such as patches and code changes to be accessed, consumed, and distributed to endpoints 106A and 106B (generally, endpoint 106 or endpoints 106) of the managed network 110.

In the managed network 110, the management device 102 may be operable to receive a first status communication from a first endpoint device 106a. The first status communication may include a product update identifier, such as a patch identifier, a code change identifier, and the like. The first status communication may have a first status time for the first endpoint device 106a to indicate when the first status communication was computed at the first endpoint device 106a. The product update identifier (e.g., the patch identifier) may be associated with a product update (e.g., a patch). A ring group identifier may be associated with a ring group. A ring group may be a group of one or more endpoint devices operable to receive a software update deployment (e.g., a patch deployment).

The management device 102 may be operable to receive a second status communication from a second endpoint device 106b. The second status communication may include a product update identifier, such as a patch identifier, a code change identifier, or the like. The second status communication may have a second status time for the second endpoint device 106a to indicate when the second status communication was computed at the second endpoint device 106a. A second product update identifier (e.g., the second patch identifier) may be associated with a second product update (e.g., a second patch).

Embodiments of the present disclosure provide a technical improvement to conventional patch management systems. For instance, in some conventional patch management systems, endpoints are managed at the device level without knowledge of patches at an aggregate level. An administrator may review a patch at a device level but does not have visibility regarding the patches at the aggregate level. Instead, the administrator is conducting a review based on a perceived and incomplete knowledge of which patches have been deployed in the managed network. For instance, the administrator may not know that a particular set of endpoints have installed a particular patch or are in the process of installing another patch. Thus, these conventional patch management systems may suffer from inefficiencies resulting from this incomplete knowledge regarding the patches at the endpoints.

For instance, one or more of the patches may not be installed at one or more endpoint devices. These patches may be reviewed by the administrator at the device level but, without the knowledge of patches at an aggregate level, the administrator may not efficiently determine which patches remain uninstalled in the managed network. Because these patches are visualized one device at a time, technical and computing resources allocated to troubleshooting the patch deployment process may be wasted. Similarly, because the patches at the endpoint devices may be difficult to visualize, up-to-date patches may not be included on the endpoint devices. Thus, these endpoint devices may persist in an out-of-date or unpatched state.

Some examples of the present disclosure improve conventional patch management systems and address the inefficiencies and technical issues described above. For instance, in some examples, the management device 102 computes visualization data based on a selected time duration, in which the visualization data may include a first patch identifier, a second patch identifier, and a first ring group identifier. The management device 102 may compute a first ring group visualization using the visualization data. The visualization data may be filtered based on the first ring group to generate a patch deployment visualization, which may include a patch deployment progress for the first patch in the first ring group and for a second patch in the first ring group. The first ring group visualization and the patch deployment visualization may be provided via a user interface.

Accordingly, examples of the present disclosure are directed to a computer-centric problem and are implemented in a computer-centric environment. For instance, the examples of the present disclosure are directed to aggregated software update ring deployment in the managed network 110. Computing processes occurring in the operating environment 100 include communication and implementation of product updates that include software patches and code changes on products loaded on the endpoints 106. Communications during the processes described in this present disclosure involve the communication of data in electronic and optical forms via a network 120 and also involve the electrical and optical interpretation of the data and information.

Furthermore, the examples of the present disclosure address a technical issue that exists in a technical environment. The technical issue includes an inability of conventional patch management systems to manage and visualize aggregate patch deployment at the endpoints 106 and the inefficiencies that result therefrom. The technical problem is solved through a technical solution. For instance, the technical solution involves aggregating status data related to multiple patch distributions and across multiple distribution rings of the managed network 110. Additionally, the technical solution includes computing visualization data based on a selected time duration to enable visual display of the aggregated data and enable a holistic patch management of the managed network 110. For instance, the management device 102 may compute a first ring group visualization using the visualization data and filtering the visualization data based on a first ring group to generate a patch deployment visualization, which may include a patch deployment progress for a first patch in the first ring group and for a second patch in the first ring group.

The operating environment 100 may include the managed network 110, a third-party server 104, a support device 113, and a distribution server 112. The managed network 110 includes the management device 102 that may communicate with the third-party server 104, the support device 113, the endpoints 106 (which may be referred to herein as endpoint devices or devices in the present disclosure), and the distribution server 112 via the network 120. The components of the operating environment 100 are configured to communicate data and information via the network 120 to perform aggregated software update ring deployment as described in the present disclosure. Each of these components are described below.

The network 120 may include any communication network configured for communication of signals between the components (e.g., 102, 113, 108, 112, 104, and 106) of the operating environment 100. The network 120 may be wired or wireless. The network 120 may have configurations including a star configuration, a token ring configuration, or another suitable configuration. Furthermore, the network 120 may include a local area network (LAN), a wide area network (WAN) (e.g., the Internet), and/or other interconnected data paths across which multiple devices may communicate. In some examples, the network 120 may include a peer-to-peer network. The network 120 may also be coupled to or include portions of a telecommunications network that may enable communication of data in a variety of different communication protocols.

In some examples, the network 120 includes or is configured to include a BLUETOOTH® communication network, a Z-Wave® communication network, an Insteon® communication network, an EnOcean® communication network, a Wi-Fi communication network, a ZigBee communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 120 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

The third-party server 104 includes a hardware-based computer device or collection thereof that is configured to communicate with the other components of the operating environment 100 via the network 120. The third-party server 104 is configured to provide access to one or more update lists 117, portions thereof, and information pertaining to entries of the update lists 117. For instance, the third-party server 104 may host a website on which the update lists 117 are available. The third-party server 104 may host or store the update lists 117 such that information, metadata, and data related to entries on the update lists 117 may be accessed via the network 120. For instance, the management device 102 or the support device 113 may be configured to access the update lists 117 or information related to entries on the update lists 117 via the network 120. In some examples, the management device 102 or the support device 113 may be configured to communicate an electronic message to the third-party server 104 that accesses the update lists 117, information (e.g., update metadata) related to entries on the update lists 117, or a specific portion of the update lists 117. Some examples of example APIs for the update accessing lists 117 are available at https://www.circl.lu/services/cve-search/.

The update lists 117 may include a list of entries. The entries relate to a cybersecurity threat, a cybersecurity vulnerability, a software application code change, a patch, a hardware interface modification, or another update to a product. The entries have information related to the entries. For instance, one or more of the entries may include an identification number, an entry date, an entry summary, a link to product updates (e.g., a code change or patch), a threat severity, or some combination thereof.

An example of the third-party server 104 may be Department of Homeland Security (DHS) server(s). In this example, the update lists 117 may include lists of common vulnerabilities and exposures (CVEs) hosted by the DHS servers. Another example of the third-party server 104 may be National Institute of Standards and Technology (NIST) servers. In this example, the update lists 117 may include national vulnerability database that is hosted by the NIST servers. The NIST server may host the information assurance vulnerability alerts (IAVAs), which may be an example of the update lists 117. One with skill in the art may be familiar with other suitable examples of the third-party server 104 and the update lists 117. Lists of vulnerabilities and threats are maintained by some additional entities such as MITRE.

The depicted example of the operating environment 100 includes the support device 113. The support device 113 may be a hardware-based computer device configured to communicate data and information with the other components of the operating environment 100 via the network 120. In examples that include the support device 113, the update lists 117 may be consumed at the support device to generate an update catalog 111. The update catalog 111 includes records and information related to previous product updates (e.g., a code change or patch). As the update lists 117 become available, update metadata or other information may be appended to the update catalog 111.

The support device 113 may communicate the update catalog 111 to the management device 102 or may otherwise make available the update catalog 111. For instance, the support device 113 may also communicate the update catalog 111 to a separate host that is connected to the network 120. The update catalog 111 may be accessed from the separate host and stored on a suitable storage medium. The management device 102 may then access the update catalog 111 from the storage medium.

The update catalog 111 may be stored at least temporarily at the management device 102. In other instances, the update catalog 111 may be stored remotely and accessed by the management device 102 via the network 120. In FIG. 1, the update catalog 111 is depicted as being communicated outside the network 120. In some examples, the update catalog 111 may be communicated or accessed via the network 120.

In some examples, the operating environment 100 may not include the support device 113. In these examples, the management device 102 might directly consume information of the update lists 117.

The depicted example of the operating environment 100 includes the distribution server 112. The distribution server 112 may be a hardware-based server configured to communicate data and information with the other components of the operating environment 100 via the network 120. The distribution server 112 may be configured to store published product updates (e.g., a code change or patch) or instructions related to published product updates. For example, in some examples, the management device 102 may communicate one or more product updates to the distribution server 112. One or both of the endpoints 106 may then access the product updates at the distribution server 112. After the product updates are accessed, the product updates may be implemented at one or both of the endpoints 106 to modify code of one of the products 115A or 115B on the endpoints 106. An example of the distribution server 112 may include a Windows® Server Update Services (WSUS) server.

In the depicted example, the distribution server 112 is not included in the managed network 110. In some examples, the distribution server 112 may be included in the managed network 110. For instance, in some examples in which the distribution server 112 includes the WSUS server, it may be included in the managed network 110.

In some examples, the operating environment 100 may omit the distribution server 112. Additionally or alternatively, the distribution server 112 may be used for a portion of product updates (e.g., a code change or patch) and not used for another portion of the product updates.

The managed network 110 includes the management device 102 and the endpoints 106. The managed network 110 is implemented to enable management of the endpoints 106 by the management device 102. To implement the managed network 110, the endpoints 106 may be enrolled. After the endpoints 106 are enrolled, ongoing management of the endpoints 106 may be implemented by the management device 102. The ongoing management may include overseeing and dictating at least a part of the operations at the endpoints 106 as well as dictate or control product updates (e.g., a code change or patch) implemented at the endpoints 106 as described in the present disclosure.

The management device 102 is configured to manage product updates (e.g., a code change or patch) at the endpoints 106. In general, management of the product updates may include determining which product updates pertain to product(s) 115A and 115B (collectively, products 115), to determine which of the product updates to distribute to the endpoints 106, and to distribute the product updates to the endpoints 106 such that the product updates may be locally implemented. Implementation of the product updates at the endpoints 106 include modification to computer code, programming code, or computer-executable instructions of a program that comprise the products 115.

The endpoints 106 may include hardware-based computer systems that are configured to communicate with the other components of the operating environment 100 via the network 120. The endpoints 106 may include any computer device that may be managed by the management device 102 and/or have been enrolled in the managed network 110. Generally, the endpoints 106 include devices that are operated by the personnel and systems of an enterprise or store data of the enterprise. The endpoints 106 might include workstations of an enterprise, servers, data storage systems, printers, telephones, internet of things (IoT) devices, smart watches, sensors, automobiles, battery charging devices, scanner devices, etc. The endpoints 106 may also include virtual machines, which may include a portion of a single processing unit or one or more portions of multiple processing units, which may be included in multiple machines. The endpoints 106 may be referred to as managed endpoints when the endpoints 106 are included in the managed network 110.

The endpoints 106 include the products 115 and an agent 119A or 119B. For instance, in the depicted example, a first endpoint 106A may include first products 115A and a first agent 119A and a second endpoint 106B may include second products 115B and a second agent 119B. The first and second agents 119A and 119B are generally referred to as agent 119 or agents 119 and the first products 115A and the second products 115B are generally referred to as products 115 or products 115.

The agents 119 may be locally installed at least temporarily on the endpoints 106. For instance, the agents 119 may be installed on the endpoints 106 when the endpoints 106 are enrolled in the managed network 110 or when a particular service is loaded at the endpoints 106. The agents 119 may have access to information related to the products 115 and may be configured to communicate the information such as product metadata related to the products 115 to the management device 102. For instance, the first agent 119A may have access to information related to the first products 115A. On its own or responsive to a request (from the management device 102 or another endpoint 106), the first agent 119A may communicate the information related to the first products 115A to the management device 102. The information related to the first products 115A may include a current inventory of the first products 115A as well as information or product metadata related to the first products 115A such as version, vendor, type, hardware integrations, size, privacy policy, software interfaces, and the like. The agents 119 may also implement administrative and/or management processes within the managed network 110.

The products 115 may include applications of any kind or type. Some examples of the products 115 may include software applications, enterprise software, operating systems, and the like. The first products 115A may not be the same as the second products 115B. For instance, the first products 115A may include a first set of software applications while the second products 115B may include a second set of software applications which may include at least one software application that is not included in the first set of software applications.

The management device 102 may include a hardware-based computer system that is configured to communicate with the other components of the operating environment 100 via the network 120. The management device 102 may be associated with an administrator 108. The administrator 108 may be an individual, a set of individuals, or a system that interfaces with the management device 102. In some examples, the administrator 108 may provide input to the management device 102. The input provided by the administrator 108 may form the basis of some computing processes performed by the management device 102. For example, the administrator 108 may provide user input at a user interface associated with the management device 102. The user input may indicate that the administrator 108 intends on publishing a subset of recommended product updates. The user input may take the form of a selection of an icon or button on the management device 102.

The management device 102 may include an update management module 116 (in the Figures, “update MGMT module”). The update management module 116 may be configured for automated software management of the endpoints 106 of the managed network 110.

The update management module 116 may receive a first status communication from a first endpoint 106a and a second status communication from a second endpoint 106b. The first status communication may be sent from a first agent 119a on the first endpoint 106a and the second status communication may be sent from a second agent 119b on the second endpoint 106b. The first status communication and/or the second status communication may include: (i) a product update identifier such as a patch identifier, a code change identifier, and the like. The first status communication may include a first status time for the first endpoint device. The first status time may be used to indicate when the first status communication was computed at the first endpoint device. The second status communication may include a second status time for the second endpoint device. The second status time may be used to indicate when the second status communication was computed at the second endpoint device.

The product update identifier (e.g., patch identifier) may be any suitable data field suitable to identify the product update (e.g., the patch). The product update identifier may be a specific identifier value that correlates with the product update. For example, the product update identifier may include a selected number of bits to distinguish the product update from other product updates. For instance, the product update identifier may be a patch identifier. In this example, the patch identifier may include a selected number of bits to distinguish the patch identified by the patch identifier from other patches.

The first status time and/or the second status time (or more generally, the status time) may be used to indicate when the first status communication and/or the second status communication (or more generally the status communication), respectively, are computed. The status time may be any suitable field for providing a time for the status communication. For example, the status time may be a timestamp in a format with a selected precision (e.g., microseconds, nanoseconds, or the like). The timestamp may be stored using a selected number of bits (e.g., a 64-bit unsigned fixed-point number, or the like).

The update management module 116 may identify the ring group based on the ring group identifier. The ring group may include any suitable number of endpoint devices. In one example, the ring group may include the first endpoint device and the second endpoint device. The ring group may be used to aggregate a number of endpoint devices for product update rollout (e.g., patch rollout). For example, a first ring group may be used for a product update rollout (e.g., patch rollout) at a first time, the second ring group may be used for a product update rollout (e.g., patch rollout) at a second time, and a third ring group may be used for a product update rollout (e.g., patch rollout) at a third time.

The ring group identifier may be any suitable data field suitable to identify the ring group. The ring group identifier may include a selected number of bits to distinguish the ring group from a different ring group. In one example, the ring group identifier may be operable to identify a first ring group having a selected number of product updates (e.g., patches). A second ring group identifier may be operable to identify a second ring group having a selected number of product updates (e.g., patches) that may be different from the product updates (e.g., patches) in the first ring group. A third ring group identifier may be operable to identify a third ring group having a selected number of product updates (e.g., patches) that may be different from the product updates (e.g., patches) in the first ring group and in the second ring group. Generally, an nth ring group identifier may be operable to identify an nth ring group having a selected number of product updates (e.g., patches) that may be different from product updates (e.g., patches) in other ring groups. N is any suitable value such as an integer greater than 3.

The update management module 116 may store a mapping between a ring group identifier and the members of the ring group. For example, the update management module may store a mapping between the first ring group identifier and the first ring group, the second ring group identifier and the second ring group, the third ring group identifier and the third ring group, and/or an nth ring group identifier and an nth ring group. The update management module 116 may re-assign ring group membership based one or more of last known physical location, device type, user role, or the like. The group membership may be updated and stored when each update for each software update (e.g., patch) is received and processed.

The update management module 116 may compute visualization data based on a selected time duration. The visualization data may include one or more patch identifiers (e.g., a first patch identifier and a second patch identifier) and one or more ring group identifiers (e.g., a first ring group identifier). The visualization data may further include any data used to facilitate knowledge about patch deployment of one or more patches in one or more ring groups. The selected time duration for computing the visualization data may be any suitable time duration. For example, the selected time duration may be less than or equal to one or more of a year, a month, a day, an hour, a minute, a second, a millisecond, a nanosecond, or the like. The update management module 116 may compute a ring group visualization using the visualization data.

The update management module 116 may filter the visualization data based on the ring group (e.g., a first ring group) to generate a patch deployment visualization. The patch deployment visualization may include a patch deployment progress for one or more patches (e.g., for a first patch in the first ring group and for a second patch in the first ring group). The update management module 116 may provide the ring group visualization (e.g., the first ring group visualization) and the patch deployment visualization via a user interface.

The update management module 116 may receive a third status communication from a third endpoint device. The third status communication may include a patch identifier, a second ring group identifier, and a third status time for the third endpoint device. The second ring group identifier may be different from the first ring group identifier. The third status time may be different from the first status time and the second status time. The patch identifier received from the third status communication may be different from the patch identifier received from one or more of the first status communication or from the second status communication. The update management module 116 may identify a second ring group based on the second ring group identifier. The update management module 116 may compute a second ring group visualization using additional visualization data (e.g., second visualization data). The additional visualization data may include the second ring group identifier and the patch identifier received from the third status communication. The update management module 116 may filter the visualization data based on the second ring group to generate a second patch deployment visualization, wherein the second patch deployment visualization includes a second patch deployment progress for the third patch in the second ring group. The update management module 116 may provide the second ring group visualization and the second patch deployment visualization via a user interface.

The update management module 116 may receive one or more additional status communications from one or more additional endpoint devices. The one or more additional status communications may include one or more additional patch identifiers for one or more additional patches, one or more additional ring group identifiers, and one or more additional status times for the one or more additional endpoint devices. The update management module 116 may identify one or more additional ring groups based on the one or more additional ring group identifiers. The update management module 116 may compute an additional ring group visualization using additional visualization data. The visualization data may include the one or more additional ring group identifiers. The update management module 116 may filter the additional visualization data based on the one or more additional ring groups to generate an additional patch deployment visualization. The additional patch deployment visualization includes an additional patch deployment progress for the one or more additional patches in the one or more additional ring groups. The update management module 116 may provide the additional ring group visualization via the user interface.

The update management module 116 may compute a patch deployment action based on one or more additional status communications. The patch deployment action may include one or more of a change in a promotion status, a device troubleshooting action, a patch troubleshooting action, or the like.

The update management module 116 may compute a product update (e.g., patch) promotion status based on the patch state associated with one or more of the first endpoint device or the second endpoint device. The product update (e.g., patch) promotion status may include one or more of a promotion to a higher ring group, a promotion pause, an un-promotion to a lower ring group, or the like. The product update (e.g., patch) may be promoted to a higher ring group when the product update (e.g., patch) is moved to a ring group that has a higher deployment percentage. For example, a first ring group may deploy a product update (e.g., patch) on 1% of endpoint devices, a second ring group may deploy a product update (e.g., software patch) on 10% of endpoint devices, and a third ring group may deploy a product update (e.g., patch) on 89% of endpoint devices.

The update management module 116 may receive an additional status communication from the first endpoint device. The additional status communication may include one or more of a product update identifier or an additional status time. The additional status communication may include additional status information relating to the first endpoint device or the product update (e.g., patch). For example, the additional status communication may include the updated product update deployment progress (e.g., updated patch deployment progress) and the update management module 116 may identify the updated product update deployment progress (e.g., updated patch deployment progress) for the first endpoint device as completed. When the update management module 116 identifies the product update (e.g., patch) for the first endpoint device as completed, the update management module 116 may update the visualization data based on the updated product update deployment progress (e.g., patch deployment progress) to generate an updated product update deployment visualization (e.g., updated patch deployment visualization). The updated product update deployment visualization (e.g., updated patch deployment visualization) may include an updated product update deployment progress (e.g., an updated patch deployment progress) for the product update (e.g., patch).

The update management module 116 may compute ring group data including one or more of ring group configuration data, ring group policy group data, a ring group product update deployment threshold (e.g., ring group patch deployment threshold), a ring group soak time duration, a ring group promotion time, a ring group next promotion, a ring group name, a ring group number of product updates (e.g., ring group number of patches), a ring group product update addition (e.g., a ring group patch addition), a ring group product update removal (e.g., a ring group patch removal), a ring group last modified, a ring group last edited, and the like.

The ring group configuration data may include a name associated with the configuration of the product update (e.g., patch) for a ring group. The ring group configuration data may include data relating to the deployment of the different product updates (e.g., patches) in the ring group. The ring group policy group data may include data relating to a collection of endpoint devices for a ring group. The ring group product update (e.g., patch) deployment threshold may be a value to determine a promotion status for a product update (e.g., patch) for a ring group. For example, when a product update (e.g., patch) has been installed on a threshold number of endpoint devices, then the product update (e.g., the patch) may be deployed in a different ring group. The ring group soak time duration may be the time duration since the product update deployment has been approved (e.g., by an administrator) for the ring group and the installation of the product update for the ring group. The ring group promotion time may be the time at which a promotion determination is computed for endpoint devices in a ring group. A ring group number of product updates (e.g., patches) may be the number of product updates (e.g., patches) in a ring group. A ring group product update (e.g., patch) addition may be a product update (e.g., patch) that has been added to a ring group. A ring group product update (e.g., patch) removal may be a product update (e.g., patch) that has been removed from a ring group. A ring group last modified may be a field that indicates when the ring group has been last modified. A ring group last edited may be a field that indicates when the ring group has been last edited.

The update management module 116 may receive input from a user interface. The user interface may be on a remote device. The input may be operable to filter the patch deployment visualization based on input from the user interface.

The status communication (e.g., first status communication, second status communication, third status communication, nth status communication, etc.) may include one or more of a device name (e.g., an endpoint device name), a product update installation progress (e.g., a patch installation progress), a product update deployment start time (e.g., a patch deployment start time), a product update deployment elapsed time (e.g., a patch deployment elapsed time), a product update status (e.g., a patch status), a product update result (e.g., a patch result), or the like.

The device name may be any suitable data field having a selected number of bits (e.g., a 64-bit unsigned fixed point number). The product update installation progress may identify the ratio or percentage of the software update that has been completed. The product update deployment start time may identify a timestamp when the product update deployment began. The product update deployment elapsed time may identify a time duration since the product update deployment began. The product update status may identify the state of the product update compared to successful deployment and may be one or more of soaking, to be assessed, promoted, not promoted, not started, in progress, pending reboot, success, failed, or the like. The product update result may be one or more of success, failed, unknown, access denied, error disk full, file not found, install failure, install language unsupported, open failed, patch target not found, success with reboot required, or the like.

The status communication (e.g., first status communication, second status communication, third status communication, nth status communication, or the like) may include one or more of a product update name (e.g., patch name), a product update severity (e.g., a patch severity), a vulnerability risk rating (VRR) group, a product update (e.g., patch) installation progress, a product update (e.g., patch) installation date, a product update (e.g., patch) soak duration, a product update status (e.g., patch status), or the like.

The product update severity may indicate an urgency with which the software update may be installed. The product update severity may include one or more of critical, security-related, recommended, or the like. A critical product update severity may be indicated when a product update is to be installed as soon as possible. A security-related product update may be indicated when: (i) related to detection, (ii) informational, (iii) applicable to security policies, or the like. A recommended product update severity may be indicated when the product update may not be critical and may not be security-related but may be applied for device maintenance.

The product update name may be any suitable data field having a selected number of bits (e.g., a 64-bit unsigned fixed point number). The VRR group may be a numerical score between 0 and 10 that may represent the risk posed by a given vulnerability. The product update installation progress may indicate a ratio or percentage for installation of the product update. The product update installation date may indicate the date on which the product update was installed. The product update soak duration may indicate a time duration since the product update deployment has been approved (e.g., by an administrator) and the installation of the product update at the endpoint. The product update state may indicate when the product update is one or more of soaking, promoted, not promoted, to be assessed, or the like.

The agent 119, the update management module 116, the products 115, and components thereof may be implemented using hardware including a processor, a microprocessor (e.g., to perform or control performance of one or more operations), a field-programmable gate array (FPGA), or an application-specific integrated circuit (ASIC). In some other instances, the agent 119, the update management module 116, the products 115, and components thereof may be implemented using a combination of hardware and software. Implementation in software may include rapid activation and deactivation of one or more transistors or transistor elements such as may be included in hardware of a computing system (e.g., the endpoints 106 or the management device 102 of FIG. 1). Additionally, software defined instructions may operate on information within transistor elements. Implementation of software instructions may at least temporarily reconfigure electronic pathways and transform computing hardware.

The managed network 110 may be associated with an enterprise, a portion of an enterprise, a government entity, or another entity or set of devices (e.g., a management device 102, a support device 113, endpoints 106, or a distribution server 112). In some examples, the management device 102 may be a single server, a set of servers, a virtual device, or a virtual server in a cloud-base network of servers. In these and other examples, the update management module 116 may be spread over two or more cores, which may be virtualized across multiple physical machines.

Modifications, additions, or omissions may be made to the operating environment 100 without departing from the scope of the present disclosure. For example, the operating environment 100 may include one or more managed networks 110, one or more management devices 102, one or more support devices 113, one or more endpoints 106, one or more third-party servers 104, one or more distribution servers 112, or any combination thereof. Moreover, the separation of various components and devices in the examples described herein is not meant to indicate that the separation occurs in all examples. Moreover, it may be understood with the benefit of this disclosure that the described components and servers may generally be integrated together into a single component or server or separated into multiple components or servers.

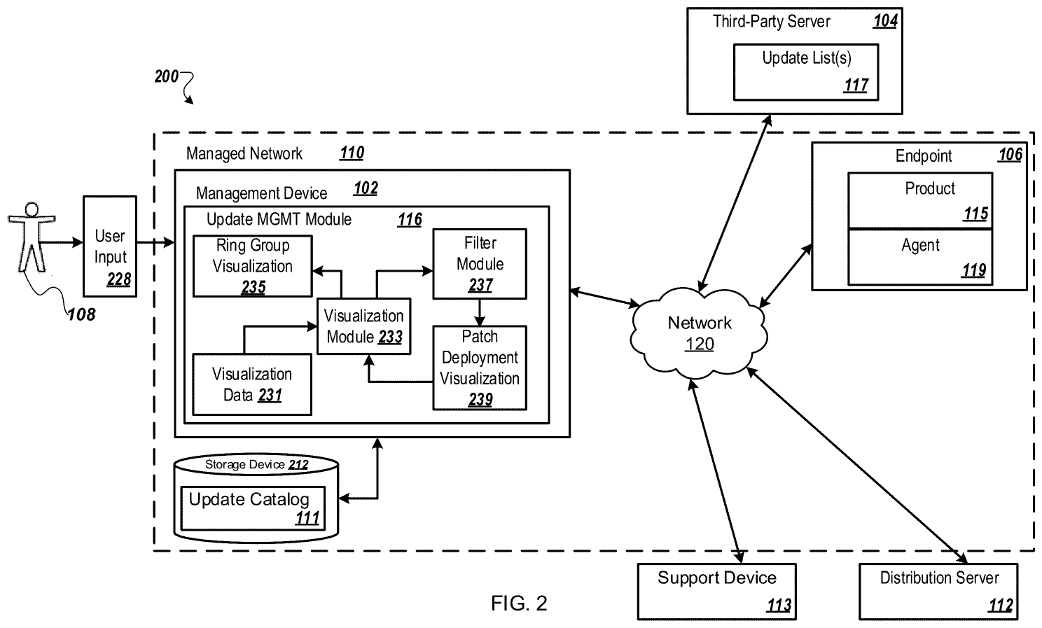

FIG. 2 depicts a block diagram of an example automated software management process 200 that may be implemented in the operating environment of FIG. 1 or another suitable environment. The management process 200 of FIG. 2 may include one or more components (102, 104, 106, 108, 110, 111, 112, 113, 117, 115, 116, and 119) described with reference to FIG. 1. Communication in the management process 200 may be via a network such as the network 120.

An update management module 116 may include a visualization module 233 and a filter module 237. The visualization module 233 may receive visualization data 231 and compute a ring group visualization 235 using the visualization data 231. The visualization module 233 may provide the visualization data 231 to the filter module 237 to filter visualization data 231 based on the ring group to generate a patch deployment visualization 239. The patch deployment visualization 239 may include a patch deployment progress for one or more patches (e.g., a first patch and a second patch in a first ring group). The update management module 116 may provide the ring group visualization 235 (e.g., a first ring group visualization) and the patch deployment visualization 239 via a user interface.

The update management module 116 may receive a first status communication from an endpoint 106. The first status communication may include a first patch identifier and a first status time for the endpoint 106. The first patch identifier may be associated with a first patch.

The update management module 116 may receive a second status communication from the endpoint 106 (or from a different endpoint 106). The second status communication may include a second patch identifier associated with a second patch and a second status time for the second endpoint device.

The update management module 116 may identify the first ring group based on the first ring group identifier. The first ring group may include the first endpoint device and the second endpoint device.

The visualization data 231 may be computed based on a selected time duration. The visualization data 231 may include the first patch identifier, the second patch identifier, and the first ring group identifier. The visualization data 231 may be sent to the visualization module which may compute a first ring group visualization 235 using the visualization data 231.

The visualization module 233 may send the visualization data 231 to a filter module 237. The filter module 237 may filter the visualization data 231 based on the first ring group to generate a patch deployment visualization 239. The patch deployment visualization 239 may include a patch deployment progress for the first patch and the second patch in the first ring group.

The update management module 116 may receive a third status communication (e.g., from a third endpoint device, not illustrated). The third status communication may include a third patch identifier for a third patch and a third status time for the third endpoint device. The update management module 116 may identify a second ring group based on the second ring group identifier. The visualization module 233 may compute a second ring group visualization using second visualization data (e.g., visualization data 231). The second visualization data may include the third patch identifier and the second ring group identifier. The filter module 237 may filter the second visualization data (e.g., visualization data 231) based on the second ring group to generate a second patch deployment visualization (e.g., patch deployment visualization 239). The second patch deployment visualization may include second patch deployment progress for the third patch in the second ring group. The second ring group visualization and the second patch deployment visualization may be provided via a user interface.

The update management module 116 may receive any suitable number of additional status communications from one or more additional endpoint devices. The one or more additional status communications may include one or more additional patch identifiers for one or more additional patches and one or more additional status times for the one or more additional endpoint devices. The update management module 116 may identify one or more additional ring groups based on one or more additional ring group identifiers.

The visualization module 233 may compute an additional ring group visualization using additional visualization data (e.g., visualization data 231) that may include the one or more additional ring group identifiers. The filter module 237 may filter the additional visualization data (e.g., visualization data 231) based on the one or more additional ring groups to generate an additional patch deployment visualization (e.g., patch deployment visualization 239) The additional patch deployment visualization may include an additional patch deployment progress for the one or more additional patches in the one or more additional ring groups. The additional ring group visualization and the additional patch deployment visualization may be provided via a user interface.

The update management module 116 may receive an additional status communication from the endpoint 106. The additional status communication may include an updated patch deployment progress. The update management module 116 may identify the updated patch deployment progress for the first endpoint device as completed. The visualization data 231 may be updated based on the updated patch deployment progress to generate an updated patch deployment visualization (e.g., patch deployment visualization 239). The patch deployment visualization 239 may be filtered based on use input 228 from the user interface. The user interface may be on a remote device.

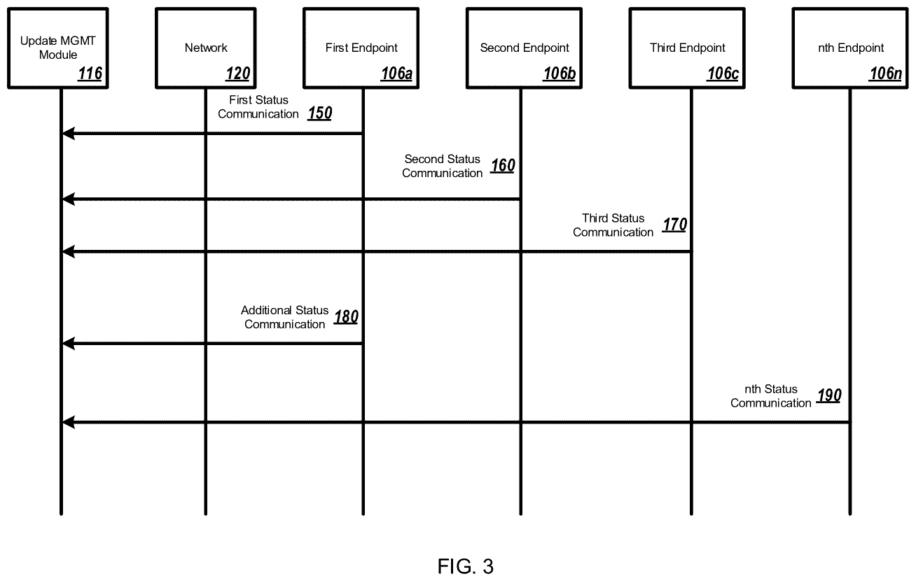

As illustrated in FIG. 3, the update management module 116 may receive a first status communication 150 from a first endpoint 106a via a network 120. The update management module 116 may receive a second status communication 160 from a second endpoint 106b via the network 120. The update management module 116 may receive a third status communication 170 from a third endpoint 106c via the network 120. The update management module 116 may receive an nth status communication 190 from an nth endpoint 106n in which n may be an integer greater than 3. The update management module 116 may receive an additional status communication 180 from the first endpoint 106a.

One or more of the first status communication 150, the second status communication 160, the third status communication 170, the additional status communication 180, or the nth status communication 190 may have different status times. The different status times may facilitate a patch deployment visualization including a patch deployment progress for one or more patches. For example, when the first status communication 150 (from a first endpoint device) includes a first patch identifier associated with a first patch, the second status communication 160 (from a second endpoint device) includes a second patch identifier associated with a second patch, and various status times are provided for the first patch and the second patch from other status communications from the first endpoint device and the second endpoint device, then the patch deployment visualization may be operable to provide the flow over time for the first patch and the second patch.

This flow over time may allow an administrator to select a patch deployment action (e.g., a change in promotion status, a device troubleshooting action, or a patch troubleshooting action). For example, the flow over time may indicate that a first patch may be nearing completion of installation in a threshold number of devices and may be nearing promotion while a second patch may be failing in installation. For the first patch, the patch deployment action may be a change in promotion status in which the first patch is promoted to a higher ring group. For the second patch, the patch deployment action may be a pause in promotion or an un-promotion to a lower ring group.

The flow over time may allow an administrator to determine a device troubleshooting action. For example, the reasons for the failure of installation of the second patch may indicate “error disk full” for a subset of devices. The administrator may determine that the disk space may be expanded for the subset of devices to facilitate installation of the second patch.

The flow over time may allow an administrator to determine a patch troubleshooting action. For example, a first status communication for a first patch received from a first endpoint 106a and an additional status communication for the first patch received from the first endpoint 106a may indicate that the patch is soaking at the first time and the second time. An aggregation of similar status communications from multiple devices and at various times may be used to compute an elapsed soaking time for the patch for more than one endpoint.

One or more of the first status communication 150, the second status communication 160, the third status communication 170, the additional status communication 180, or the nth status communication 190 may be received from different endpoints 106 that may be associated with one or more different patches. These different status communications (e.g., 150, 160, 170, 180, 190) may be used to generate a patch deployment visualization including patch deployment progress for the first patch (e.g., in a first ring group) and the second patch (e.g., in the first ring group).

One or more of the first endpoint 106a, the second endpoint 106b, the third endpoint 106c, or the nth endpoint 106n may have more than one patch deployed concurrently. The more than one patch may be deployed to the endpoints at different times while being present on the endpoints at the same time. The one or more of the first endpoint 106a, the second endpoint 106b, the third endpoint 106c, or the nth endpoint 106n may send status communications (e.g., a first status communication 150, a second status communication 160, a third status communication 170, an additional status communication 180, an nth status communication 190, or the like) for each patch that is deployed to the endpoint. For example, the first endpoint may have three different patches deployed, the second endpoint may have five different patches deployed, and the third endpoint may have nine different patches deployed. The first endpoint may send three different status communications corresponding to each of the three different patches. The second endpoint may send five different status communications corresponding to each of the five different patches. The third endpoint may send nine different status communications corresponding to each of the nine different patches.

The more than one patch of the one or more of the first endpoint 106a, the second endpoint 106b, the third endpoint 106c, or the nth endpoint 106n may be promoted and/or paused and/or demoted at different times. The different times for promotion and/or pausing and/or un-promotion may be based on successful installation of the patch at different endpoints. For example, the first endpoint 106a may have more than one patch which may be in the same ring group, e.g., three patches: patch A, patch B, and patch C with each in ring group 1. Patch A may be promoted to a higher ring group, while patch B is paused at the same ring group, and patch C is un-promoted to a lower ring group. Patch B may be promoted to the higher ring group when the additional endpoints in the ring group 1 have successfully installed patch B.

One or more of the first endpoint 106a, the second endpoint 106b, the third endpoint 106c, or the nth endpoint 106n may be associated with different ring groups. In one example, the first endpoint 106a and the second endpoint 106b may be in a first ring group, the third endpoint 106c may be in a second ring group, and the nth endpoint may be in an additional ring group. The first ring group may be associated with a first number of different patches, the second ring group may be associated with a second number of different patches, and the additional ring group may be associated with an additional number of different patches. The first ring group may be a test group, the second ring group may be a pilot group, and the additional ring group may be a product ring group. The test ring group may be used with a percentage of endpoint devices that do not exceed a first threshold. The pilot ring group may be used with a percentage of endpoint devices that are greater than the first threshold but less than a second threshold. The product ring group may be used with a percentage of endpoint devices that are greater than the second threshold.

One or more of the first endpoint 106a, the second endpoint 106b, the third endpoint 106c, or the nth endpoint 106n may communicate status communications at the same time that may be processed for a visualization. A first patch may be deployed on the first and second endpoints 106a, 106b at a first time. A second patch may be promoted to the third endpoint 106c and the nth endpoint 106n at a first time. The first and second endpoints 106a, 106b may send a status communication (e.g., first status communication 150 or second status communication 160) at the first time about the deployment of the first patch. The third endpoint 106c and the nth endpoint 106n may send a status communication (e.g., a third status communication 170 and an nth status communication 190) to the update management module 116 at the first time about the promotion of the second patch. Thus, the four endpoints (e.g., first endpoint 106a, second endpoint 106b, third endpoint 106c, and nth endpoint 106n) may collectively send four status communications about two different patches in two different patch states (e.g., recent deployment and recent promotion) at the same time. The four status communications about the two different patches in the two different patch states may be processed for visualization.

The update management module 116 may communicate multiple patches from the management device 102 to the endpoints. The multiple patches may be communicated to one or more endpoints. The multiple patches may be communicated at the same time or at different times.

The multiple patches may be present at multiple endpoints in multiple rings in different states. For example: (i) two patches may be deployed to a first endpoint 106a in a first ring, (ii) four patches may be deployed to a second endpoint 106b in the first ring, (iii) twelve patches may be deployed to a third endpoint 106c a second ring, and (iv) thirty-five patches may be deployed to an nth endpoint 106n in a third ring.

The two patches deployed to the first endpoint 106a may transition between different states. For example, one of the two patches may have been just deployed (e.g., to be assessed) while the other patch of the two patches may have been soaking for 7 days.

The four patches deployed to the second endpoint 106b may also transition between different states. One of the four patches may have been soaking for three days, another patch may have been soaking for seven days, yet another patch may have been soaking for 10 days, and yet another patch may be promoted to a different ring group when all of the patches at the endpoint in the first ring have been installed.

The twelve patches deployed to the third endpoint 106c in the second ring may transition between different states. Four of the twelve patches may have been just promoted (e.g., to be assessed) from the first ring group, another four of the twelve patches may have been soaking for seven days, another two of the twelve patches may be a day away from being promoted to the third ring group, and another two of the twelves patches may be in a not-promoted state.

The thirty-five patches deployed to the nth endpoint 106n in the third ring may also transition between different states. In some examples, twelve of the thirty-five patches may have been promoted (e.g., to be assessed) from the second ring group, another twelve of the thirty-five patches may have been soaking for between 1 and 15 days, and another eleven of the thirty-five patches may be near completion of installation across the endpoints in the third ring.

The different status communications from the multiple endpoints in the multiple rings, in which multiple patches may have multiple states, may be aggregated to facilitate visualization of the overall system. The status communications from each endpoint may be aggregated by patch, ring groups, and/or time. For example, different patches may exist at multiple endpoints in the same ring group. An aggregation of the endpoint data may allow for a visualization of patches in the multiple endpoints. In another example, aggregating by ring group may allow for a visualization of statistics about the patches deployed in the ring group or of the devices that have been patched in the ring group. In another example aggregating by time, may allow for visualization of the patch state and/or the device state over a selected period of time.

The update management module 116 may receive a first status communication 150 from the first endpoint 106a and an additional status communication 180 from the first endpoint 106a. The first status communication 150 may include a patch identifier and a first status time. The additional status communication may include the patch identifier and an additional status time. The additional status time may be different from the first status time. The additional status communication may be used to provide an updated status for the first endpoint 106a with respect to the patch.

The update management module 116 may identify the ring groups based on the ring group identifiers. The ring group identifier may be stored at the update management module 116 to provide a mapping between the ring group identifier and the members of the ring group.

The update management module 116 may compute visualization data based on a selected time duration. The visualization data may include the patch identifier and the ring group identifier. The update management module 116 may filter the visualization data based on the ring group to generate a patch deployment visualization. The patch deployment visualization may include a patch deployment progress for the patch. The ring group visualization and the patch deployment visualization may be provided via a user interface.

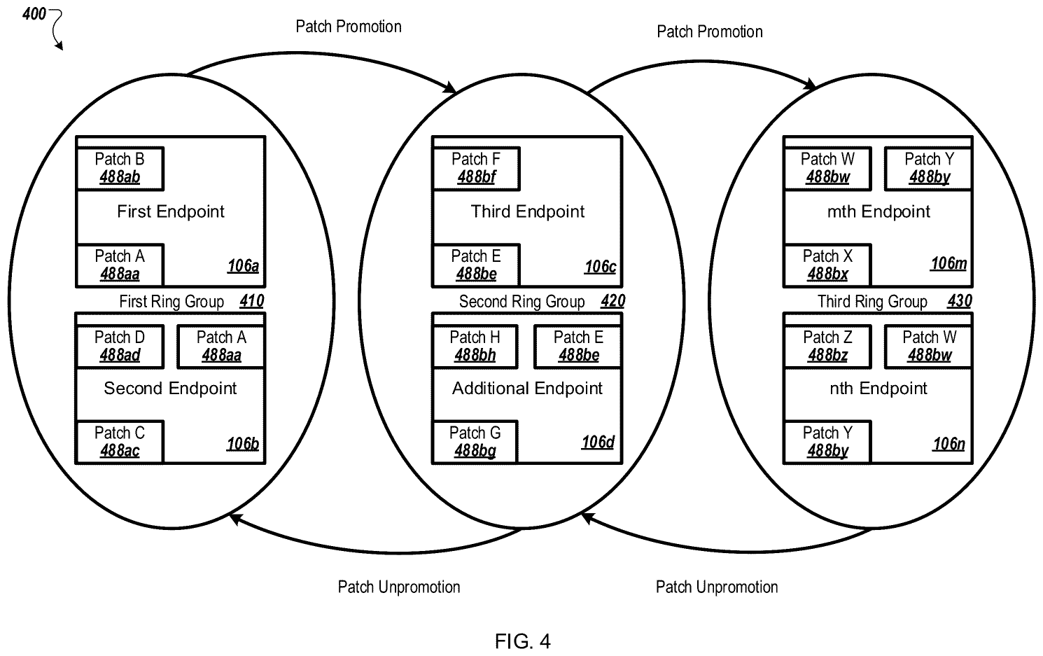

A block diagram 400 for automated software management of a managed endpoint is illustrated in FIG. 4. A first ring group 410 may include a first endpoint 106a and a second endpoint 106b. A second ring group 420 may include a third endpoint 106c and an additional endpoint 106d. A third ring group 430 may include an mth endpoint 106m and an nth endpoint 106n. The first ring group 410, the second ring group 420, and the third ring group 430 may include additional endpoints not illustrated. The number of ring groups may be any suitable positive integer (e.g., 2, 3, 4, 5, or the like).

The different ring groups 410, 420, and 430 may have different endpoints 106 which may be operable to install different product updates (e.g., patches). For example, in the first ring group 410, the first endpoint 106a may be operable to install one or more patches (e.g., Patch A 488aa and Patch B 488ab) and the second endpoint 106b may be operable to install the same patch (e.g., Patch A 488ab) and/or one or more additional patches (e.g., Patch C 488ac and Patch D 488ad). In the second ring group 420, the third endpoint 106c may be operable to install one or more additional patches (e.g., Patch E 488bc and Patch F 488bf) and the additional endpoint 106d may be operable to install one or more additional patches (e.g., Patch G 488c and Patch H 488bh) and/or some of the same patches as the third endpoint 106c (e.g., Patch 488be). In the third ring group, the mth endpoint may be operable to install one or more additional patches (e.g., Patch W 488bw, Patch X 488bx, and Patch Y 488by) and the nth endpoint may be operable to install one or more additional patches (e.g., Patch Z 488bz) and/or some of the same patches as the mth endpoint (e.g., Patch W 488bw and Patch Y 488by).

The different ring groups may be visualized by ring group. The first ring group 410 may include the first endpoint 106a and the second endpoint 106b. The one or more patches (e.g., Patch A 488aa and Patch B 488ab) for the first endpoint 106a and the one or more patches (e.g., Patch A 488aa, Patch C 488ac, and Patch D 488ad) for the second endpoint 106b may be visualized based on a selected time duration (e.g., one month). The status communications from the first endpoint 106a may include a status communication for a first patch on the first endpoint 106a (e.g., Patch A 488aa) and one or more additional patches on the first endpoint 106a (e.g., Patch B 488ab). The status communications from the second endpoint 106b may include a status communication for the one or more additional patches on the second endpoint 106b (e.g., Patch A 488aa, Patch C 488ac, and Patch D 488ad). Visualization data may be computed based on the selected time duration (e.g., one month). A first ring group visualization may be computed using the visualization data. The visualization data may be filtered based on the first ring group to generate a patch deployment visualization for the first ring group.

An additional ring group may be visualized in combination with the first ring group. A second ring group 420 may include one or more patches on a third endpoint 106c (e.g., Patch E 488bc and Patch F 488bf) and one or more additional patches one or more additional endpoints (e.g., Patch E 488be, Patch G 488bg, and Patch H 488bh on additional endpoint 106d). The status communications from the second ring group may be used for visualization. Second visualization data may be computed based on a selected time duration (e.g., one month). A second ring group visualization may be computed using the second visualization data. The second visualization data may be filtered based on the second ring group to generate a second patch deployment visualization.

One or more additional ring groups may be visualized in combination with the first ring group and the second ring group. For example, the one or more additional ring groups may include one or more additional endpoints (e.g., an mth endpoint 106m and an nth endpoint 106n). The one or more additional endpoints may include one or more additional patches (e.g., Patch W 488bw, Patch X 488bx, and Patch Y 488by for the mth endpoint 106m and Patch Z 488bz, Patch W 488bw, and Patch Y 488by for the nth endpoint 106n). Status communications from the one or more additional endpoints (e.g., an mth endpoint 106m and an nth endpoint 106n) may be used for visualization. Additional visualization data may be computed based on a selected time duration (e.g., one month). An additional ring group visualization may be computed using the additional visualization data. The additional visualization data may be filtered based on the one or more additional ring groups to generate an additional patch deployment visualization.

The availability of different ring groups may facilitate the promotion and/or un-promotion of different patches between different ring groups. A patch (e.g., Patch A) may be promoted to the second ring group 420 to be installed on endpoints (e.g., third endpoint 106c, additional endpoint 106d) in the second ring group. A patch (e.g., Patch B 488b or Patch C 488c) may be promoted to the third ring group 430 to be installed on endpoints (e.g., mth endpoint 106m, nth endpoint 106n) in the third ring group. A patch (e.g., Patch X 488x or Patch Y 488y) may be un-promoted from the third ring group 430 to the second ring group 420. A patch (e.g., patch B 488b or Patch C 488C) may be un-promoted from the second ring group 420 to the first ring group 410.

In some circumstances, a patch may be promoted to a higher ring group (e.g., from the first ring group 410 to the second ring group 420, or from the second ring group 420 to the third ring group 430, or the like) when the patch has been successfully installed at one or more endpoints in a particular ring group. For example, when Patch A 488aa is successfully installed at the first endpoint 106a and Patch A 488ab is successfully installed at the second endpoint 106b, then patch A may be promoted from the first ring group 410 to the second ring group 420.

More generally, a patch promotion status (e.g., a promotion to a higher group, a promotion pause, or an un-promotion) may be based on the patch state associated with one or more endpoint devices in a ring group. The patch state may include a patch installation success, a patch installation to be assessed, a patch installation failure, or the like.

The promotion may be initiated based on rules providing for automated promotion and/or the promotion may be initiated manually. When the promotion is initiated based on rules providing for automated promotion, the promotion may occur, e.g., when the patch to be promoted has been successfully installed at a selected number of endpoints. When the promotion is initiated manually, input from a user interface may select the patch and promote the patch to a higher ring group.

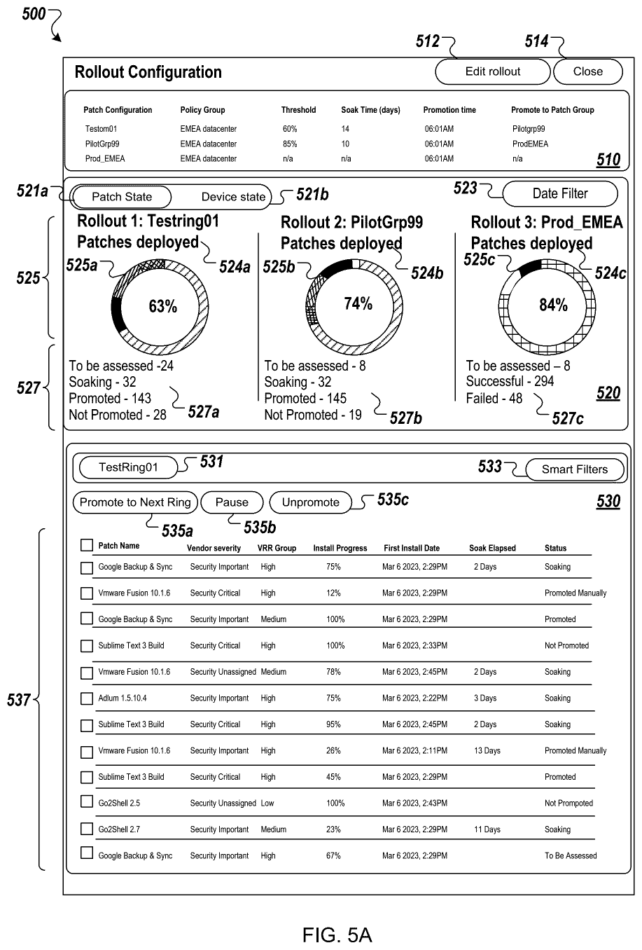

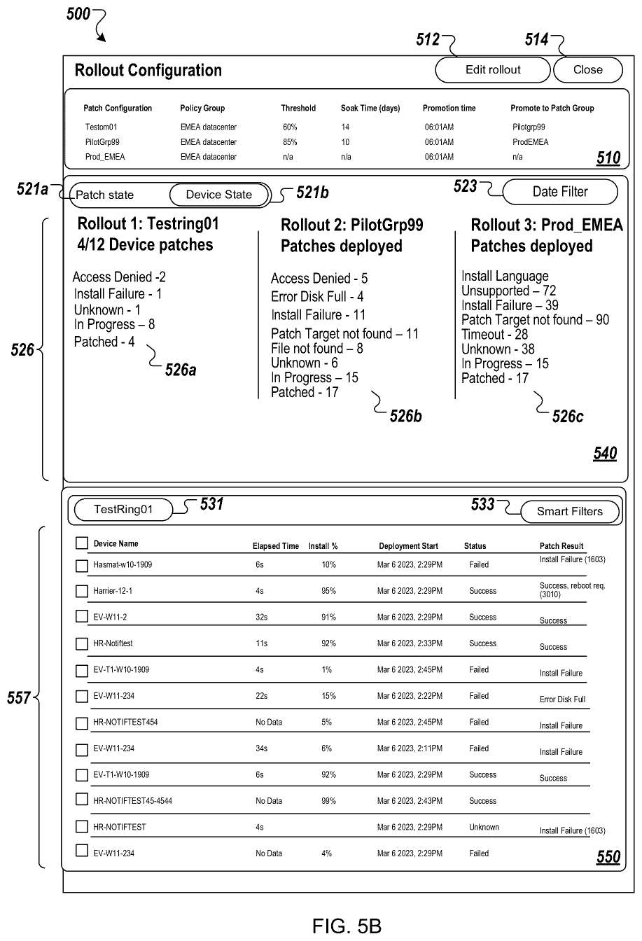

FIG. 5A illustrates a graphical user interface (GUI) 500 in which visualization data is displayed. The GUI 500 includes a first user interface (UI) portion 510, a second UI portion 520, and a third UI portion 530. The first UI portion 510 may include an edit rollout button 512 and a close button 514. The first UI portion 510 includes a title (in FIG. 5A, “rollout configuration”) and may include a list having a number of different categories (in FIG. 5A, “product update configuration and/or patch configuration”; “policy group”; “threshold”; “soak time”; “promotion time”; and “promote to patch group”). The list having the number of different categories may be filtered by a particular ring group such as a first ring group, a second ring group, a third ring group, an nth ring group, ctc. (in FIG. 5A, Testring 01; PilotGroup99; and Prod-EMEA as illustrated).

The second UI portion 520 includes a toggle button that may toggle between a patch state button 521a and a device state button 521b. The second UI portion 520 may include a date filter 523 interface operable to filter a particular time duration (e.g., 30 days from 1 Jun. 2022 to 30 Jun. 2022). When the patch state button 521a is selected, the second UI portion 520 may display an upper part 525 of the second UI portion 520 and a lower part 527 of the second UI portion 520. The upper part 525 of the second UI portion 520 may include one or more headings 524a, 524b, 524c (e.g., “Rollout 1: Testring01”; “Rollout 2: PilotGrp99”; and “Rollout 3: Prod_EMEA”) that provide identifying information about the one or more ring groups such as a ring group name. The upper part 525 of the second UI portion 520 may include one or more sub-headings (e.g., “patches deployed”) to provide additional descriptive information about the one or more ring groups.

The visualization data may be filtered based on the ring group to generate a patch deployment visualization in the upper part 525 of the second UI portion 520. The upper part 525 of the second UI portion 520 may include a visualization pertaining to one or more ring groups (e.g., first ring group visualization 525a, second ring group visualization 525b, third ring group visualization 525c). First ring group visualization 525a may include different colors, shading, patterns, or the like to indicate one or more patch states for the first ring group. As illustrated, first ring group visualization 525a includes metrics relating to, e.g., a “promoted” patch state, a “soaking” patch state, a “not promoted” patch state, and a “to be assessed” patch state.

The first ring group visualization 525a may include an overall metric (e.g., 63% as illustrated) that indicates the percentage of patch promotion and/or installation success within the selected time period (e.g., 1 Jun. 2022 to 30 Jun. 2022 as illustrated). That is, the percentage may indicate: (i) the rate of flow of patches through the 1st ring and the 2nd ring and (ii) the rate of installation of the patches in the 3rd ring. For example, the percentage 63% as shown in the first ring group visualization 525a may indicate the percentage (e.g., ((143/227)×100)=63%) of patches that are to be promoted from the first ring group to the second ring group. Also shown in the lower part 527a of the first ring group may be the number of patches that are soaking (e.g., 32), the number of patches that have not been promoted (e.g., 28), and the number of patches that are to be assessed (e.g., 24). Patches that are soaking may be patches that have been distributed on an adequate number of endpoints in a ring group and are in an observation period until the soaking time has elapsed to enable installation. Patches that are “not promoted” may be patches that have not been promoted because the failure rate has been too high (e.g., the patch has failed to install on one or more endpoints in the ring group). Patches that are “to be assessed” may be patches that have met an evaluation criterion but for which installation has not been attempted.

The second ring group visualization 525b may be similarly configured in accordance with the first ring group visualization 525a. The percentage illustrated in the second ring group visualization 525b (e.g., 74%) indicates the percentage (e.g., ((145/196)×100)=74%) of patches that are to be promoted from the second ring group to the third ring group. Also shown in the lower part 527b of the second ring group are the number of patches that are soaking (e.g., 24), the number of patches that have not been promoted (e.g., 19), and the number of patches to be assessed (e.g., 8).

The third ring group visualization 525c may be similarly configured to the first ring group visualization 525a and the second ring group visualization 525b but may show the installation percentage rather than the promotion percentage. For example, the percentage 84% as shown in the third ring group visualization 525c may indicate the percentage (e.g., ((294/351)×100)=84%) of patches that have been installed in the third ring group. Also shown in the lower part 527c of the third ring group may be the number of patches that have failed to be installed (e.g., 48) and the number of patches that are to be assessed (e.g., 9).

The overall metric as illustrated in the first ring group visualization (e.g., a promotion percentage for the first ring group to the second ring group), the second ring group (e.g., a promotion percentage for the second ring group to the third ring group), and the third ring group (e.g., an installation percentage for the third ring group) may have a high level of success in subsequent ring groups. For example, a promotion and/or installation percentage over time may be 85% or higher promotion in the first ring group, a 95% of higher promotion rate in the second ring group, and a 99% or higher success in a final group. When the promotion and/or installation percentage over time has lower values, this may indicate that the pilot group selection and/or patching process should be modified. For example, the time for patch deployment may be changed to reduced conflicts. Alternatively or in addition, other types of devices may be used in the pilot group.

The visualization data of the ring group may be filtered to generate a patch deployment visualization in the lower part 527 of the second UI portion 520. The lower part 527 includes additional information about the devices for which the patch deployment progress is provided. As illustrated, the lower part 527a of the first ring group may include device-level information about the number of devices in different patch deployments (in FIG. 5A, “promoted”, “soaking”, “not promoted”, and “to be assessed”). The lower part 527b of the second ring group and the lower part 527c of the third ring group may be similarly configured to the lower part 527a of the first ring group.

The visualization data based on the ring group may be filtered to generate one or more patch states for a selected ring group. The third UI portion 530 includes a ring group filtering button 531 and a filtering button 533. The filtering button is operable to provide a drop-down menu of different filtering options. The third UI portion 530 includes action buttons 535a-535c (in FIG. 5A, “promote to next ring 535a”, “pause 535b”, and “un-promote 535c”) associated with one or more patches associated with the selected ring group. The third UI portion 530 includes a list 537 including one or more patches filtered based on the ring group. The list 537 displays properties related to the patch such as the patch name, the vendor severity, the VRR group, the installation progress, the first installation date, the soak elapsed duration, the patch status, or another property.

The third user interface portion 530 is operable to implement a patch deployment action such as a change in promotion status. The change in promotion status may be manually selected for one or more patches using the action buttons 535a-535c (in FIG. 5A, “promote to next ring 535a”, “pause 535b”, and “un-promote 535c”). Alternatively or in addition, the change in promotion status may be performed based on automated rules without manual selection.

The second UI portion 520 and the third UI portion 530 may be used to perform a patch troubleshooting action. The properties associated with a patch displayed in the list 537 may be used to assess a patch. For example, a soaking patch status may be used to assess that the patch may use additional time before promotion, un-promotion, or a pause in promotion.

FIG. 5B illustrates another view of the GUI 500 including the first UI portion 510 of FIG. 5A, a fourth UI portion 540, and a fifth UI portion 550. The fourth UI portion 540 may be configured similarly to the second UI portion 520 of FIG. 5A and the fifth UI portion 550 may be configured similarly to the third UI portion 530 in FIG. 5A with like numerals having like functionality.

The fourth UI portion 540 includes a device state UI portion 526 that may be filtered by ring group (e.g., first ring group visualization 526a, second ring group visualization 526b, and a third ring group visualization 526c). The first ring group visualization 526a may include a reason for a patch deployment progress associated with a device such as “access denied”, “install failure”, “unknown”, “in progress”, and “patched” in FIG. 5B). Additional reasons for a patch state may be included as shown in the second ring group visualization 526b such as “error disk full”, “patch target not found”, “file not found”, etc. Yet additional reasons for a patch deployment progress may be included as shown in the third ring group visualization 526c such as “install language unsupported”, “timeout”, and the like.

The fifth UI portion 550 may include a list 557 having one or more devices (e.g., endpoints 106 described elsewhere in the present disclosure). The one or more devices may have one or more properties including a device name, a patch installation completion (e.g., “install %”), a patch deployment start (e.g., “deployment start”), an elapsed time, a patch status (e.g., failed, success, unknown, and like), and a patch result (e.g., install failure; success, reboot required; success; error disk full; or the like).

The fourth UI portion 540 and the fifth UI portion 550 may be used to compute a patch deployment action. The properties associated with a device displayed in the list 557 may be used to assess a device. For example, a “success, reboot required” patch result may be used to assess that the device may be rebooted to complete installation of the patch.

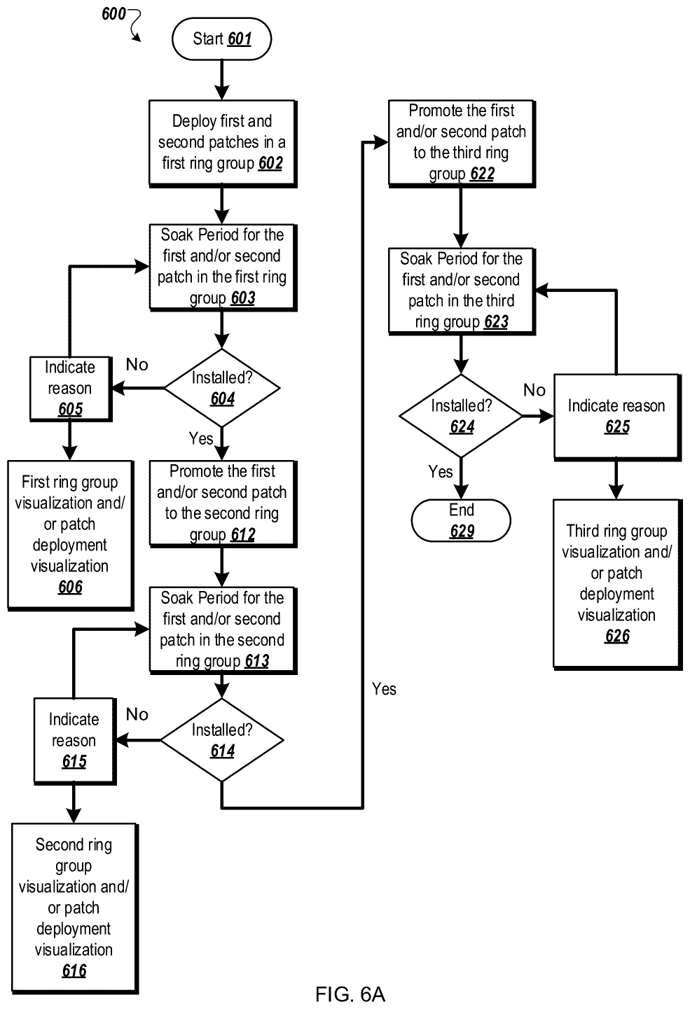

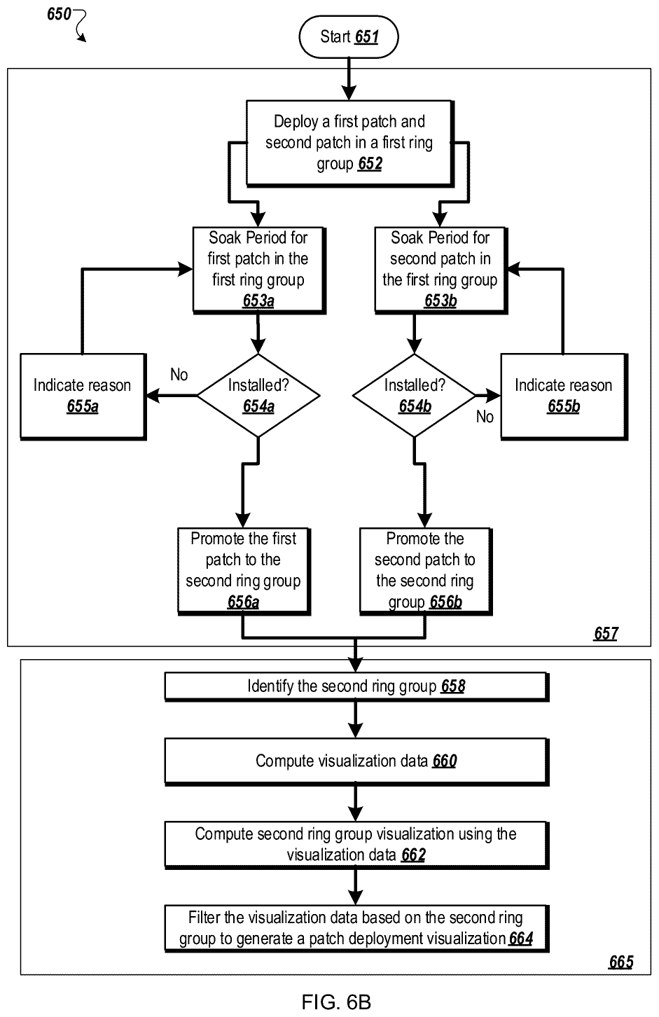

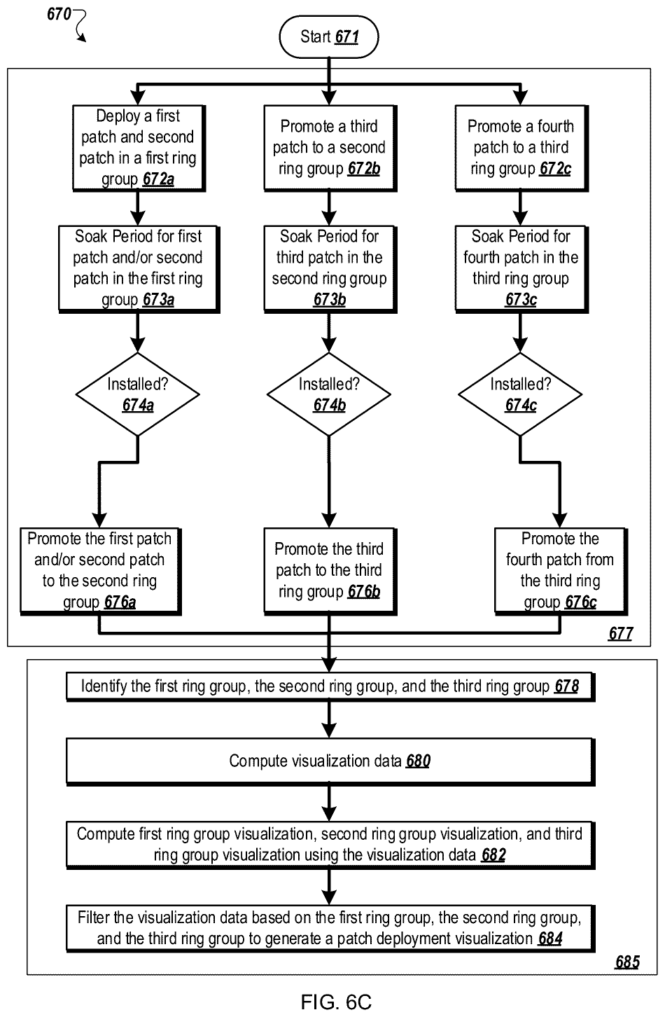

As illustrated in FIG. 6A, process flow 600 is provided for automated software management. The start operation 601 may initiate the process flow 600. The process flow 600 may be operable to deploy a first and second patch in a first ring group, as shown by operation 602. The process flow 600 may be operable to have a soak period for the first and second patch in the first ring group, as shown by operation 603. The soak period may differ for the first and second patch so that the first patch and the second patch proceed through the process flow 600 at different speeds. For example, the first patch may have a soak period of one week while the second patch may have a soak period of two weeks. The first patch may proceed to the next operation before the second patch has finished its soak period.

The process flow 600 may be operable to determine whether the first and second patch has been installed in one or more devices (e.g., the endpoints 106) in the first ring group, as shown by operation 604. When the first and/or the second patch has not been installed in the one or more devices in the first ring group, the process flow 600 may be operable to indicate a reason, as shown by operation 605. After a reason has been indicated (e.g., by computing the reason and providing the reason to a user interface), the soak period may continue for the first and/or second patch in operation 603. Alternatively or in addition, a first ring group visualization and/or a patch deployment visualization may be provided via a user interface, as shown by operation 606. The first ring group visualization and/or the patch deployment visualization may also be provided via the user interface after any of operations 601, 602, 603, and/or 604. When the first and/or second patch has been installed in the one or more devices in the first ring group, the process flow 600 may be operable to promote the first and/or second patch to the second ring group, as shown by operation 612.

The process flow 600 may be operable to have a soak period for the first and/or second patch in the second ring group, as shown by operation 613. The process flow 600 may be operable to determine whether the first and/or second patch has been installed in one or more devices in the second ring group, as shown by operation 614. When the first and/or second patch has not been installed in the one or more devices in the second ring group, the process flow 600 may be operable to indicate a reason, as shown by operation 615. After a reason has been indicated (e.g., by computing the reason and providing the reason to a user interface), the soak period for the first and/or second patch may continue in operation 613. Alternatively or in addition, a second ring group visualization and/or a patch deployment visualization may be provided via a user interface, as shown by operation 616. The second ring group visualization and/or the patch deployment visualization may also be provided via the user interface after any of operations 612, 613, and/or 614. When the first and/or second patch has been installed in the one or more devices in the second ring group, the process flow 600 may be operable to promote the first and/or second patch to the third ring group, as shown by operation 622.

The process flow 600 may be operable to have a soak period for the first and/or second patch in the third ring group, as shown by operation 623. The process flow 600 may be operable to determine whether the first and/or second patch has been installed in one or more devices in the third ring group, as shown by operation 624. When the first and/or second patch has not been installed in the one or more devices in the third ring group, the process flow 600 may be operable to indicate a reason, as shown by operation 625. After a reason has been indicated (e.g., by computing the reason and providing the reason to a user interface), the soak period for the first and/or the second patch may continue in operation 623. Alternatively or in addition, a third ring group visualization and/or a patch deployment visualization may be provided via a user interface, as shown by operation 626. The third ring group visualization and/or the patch deployment visualization may also be provided via the user interface after any of operations 622, 623, and/or 624. When the first and/or second patch has been installed in the one or more devices in the third ring group, the process flow 600 may be operable to end the process flow 600, as shown by operation 629.

The process flow 600 illustrated in FIG. 6A may include any suitable number of ring groups. For example, after operation 629, the process flow 600 may be operable to promote the patch to an nth ring group and continue the operations as provided by any of operations 623, 624, 625, 626, and/or 629 with respect to an nth ring group in which n may be any suitable integer greater than three. The process flow 600 illustrated in FIG. 6A may include any number of patches and/or of different devices in one or more of the first ring group, the second ring group, the third ring group, or the nth ring group (not illustrated).

As illustrated in FIG. 6B, a process flow 650 is provided for automated software management. The start operation 651 may initiate the process flow 650. The process flow 650 may be operable to deploy a first patch (e.g., in a first endpoint device) and second patch (e.g., in a second endpoint device) in a first ring group, as shown in operation 652. Although a first ring group is illustrated, any number of ring groups may be included. In addition or alternatively, any number of patches may be deployed in two or more ring groups.

The process flow 650 may be operable to have a soak period for a first patch in the first ring group, as shown in operation 653a, and a soak period for a second patch in the first ring group, as shown in operation 653b. The process flow 650 may be operable to determine whether the first patch has been installed, as shown in operation 654a, or whether the second patch has been installed, as shown in operation 654b. When the patch has not been installed in the one or more devices in the first ring group, the process flow 650 may be operable to indicate a reason for the first patch, as shown in operation 655a, or for the second patch, as shown in operation 655b. After a reason has been indicated (e.g., by computing the reason and providing the reason to a user interface), the soak period may continue in operation 653a for the first patch or in operation 653b for the second patch.

When the first patch has been installed in the one or more devices in the first ring group, the process flow may be operable to promote the first patch to the second ring group, as shown by operation 656a. When the second patch has been installed in the one or more devices in the first ring group, the process flow 650 may be operable to promote the second patch to the second ring group, as shown by operation 656b.

The second ring group may be identified, as shown in operation 658, based on the patches (e.g., the first patch in a third endpoint device after promotion and the second patch in a fourth endpoint device after promotion). When the first patch and the second patch have been promoted to the second ring group, for example, then visualization data may be computed, as shown in operation 660, based on a selected time duration (e.g., one month). As shown in operation 662, a second ring group visualization may be computed using the visualization data. As shown in operation 664, the visualization data may be filtered based on the second ring group to generate a patch deployment visualization.

The process flow 657 may be repeated for any suitable number of additional patches, endpoints, and ring groups to promote, pause, and/or un-promote the additional patches between different ring groups and endpoints. The process flow 665 may be repeated for any suitable number of additional ring groups to generate a patch deployment visualization filtered by ring group.

The operations include computing the visualization data, computing the first ring group visualization, filtering the visualization data, and generating the patch deployment visualization may be performed after any of the operations described with respect to FIG. 6B.

Although the operations have been depicted at particular points in time, the sequence of operations may occur at different points in time. For example, each of the operations 653a, 654a, 655a, and 656a may occur before and/or after any of the operations 653b, 654b 655b, and/or 656b.

As illustrated in FIG. 6C, a process flow 670 is provided for automated software management. The start operation 671 may initiate the process flow 670. The process flow 670 may be operable to deploy a first patch (e.g., in a first endpoint device) and second patch (e.g., in a second endpoint device) in a first ring group, as shown in operation 672b. The process flow may be operable to deploy a third patch (e.g., in a third endpoint device in a second ring group), as shown in operation 672a. The process flow may be operable to deploy a fourth patch (e.g., in a fourth endpoint device in a third ring group), as shown in operation 672c. Additional patches may be deployed in the first ring group, second ring group, and third ring group, although not illustrated. Although three ring groups are illustrated, any number of ring groups may be included.

The process flow may be operable to have a soak period for a first patch and a second patch in the first ring group, as shown in operation 673a, a soak period for a third patch in the second ring group, as shown in operation 673b, and a soak period for a fourth patch in the third ring group, as shown in operation 673c. The process flow may be operable to determine whether the first patch and/or second patch (or any additional patches) have been installed, as shown in operation 674a, or whether the third patch (or any additional patches) have been installed, as shown in operation 674b, or whether the fourth patch (or any additional patches) have been installed, as shown in operation 674c. When a patch has not been installed in the one or more devices in the first ring group, the one or more devices in the second ring group, or the one or more devices in the third ring group, the process flow 650 may be operable to indicate a reason. After a reason has been indicated (e.g., by computing the reason and providing the reason to a user interface), the soak period may continue in operation 673a for the first patch and/or second patch (or any additional patches) or in operation 673b for the third patch (or any additional patches) or in operation 673c for the fourth patch (or any additional patches).

When the first patch and/or second patch (and/or any additional patches) have been installed in the one or more devices in the first ring group, the process flow may be operable to promote the first patch and/or the second patch (and/or any additional patches) to the second ring group, as shown by operation 676a. When the third patch (and/or any additional patches) have been installed in the one or more devices in the second ring group, the process flow may be operable to promote the third patch (and/or any additional patches) to the third ring group, as shown by operation 676b. When the fourth patch (and/or any additional patches) have been installed in the one or more devices in the third ring group, the process flow may be operable to promote the fourth patch (and/or any additional patches) from the third ring group, as shown by operation 676c. When the fourth patch (and/or any additional patches) have been promoted from the third ring group, the fourth patch (and/or any additional patches) may be promoted to an additional ring group. Alternatively or in addition, the fourth patch (and/or any additional patches) may not be promoted to any additional ring groups when the third ring group is a final ring group (e.g., there are no other ring groups for the fourth patch to be promoted to).

The first ring group, second ring group, and the third ring group may be identified, as shown in operation 678, based on the patches (e.g., the first patch, the second patch, the third patch, and the fourth patch). When the first patch and the second patch have been promoted to the second ring group, for example, then visualization data may be computed, as shown in operation 680, based on a selected time duration (e.g., one month). When the third patch has been promoted to the third ring group, for example, then visualization data may be computed, as shown in operation 680, based on a selected time duration (e.g., one month). When the fourth patch has been promoted from the third ring group, for example, then visualization data may be computed, as shown in operation 680, based on a selected time duration (e.g., one month). The timing of the visualization data computation is provided as an example and may be computed after any of the operations described with respect to FIG. 6C.

As shown in operation 682, a first ring group visualization, a second ring group visualization, and/or a third ring group visualization may be computed using the visualization data. As shown in operation 684, the visualization data may be filtered based on the first ring group, the second ring group, and/or the third ring group to generate a patch deployment visualization.

The process flow 677 may be repeated for any suitable number of additional patches, endpoints, and ring groups to promote, pause, and/or un-promote the additional patches between different ring groups and endpoints. The process flow 685 may be repeated for any suitable number of additional ring groups to generate a patch deployment visualization filtered by ring group.

The operations include computing the visualization data, computing the first ring group visualization, filtering the visualization data, and generating the patch deployment visualization may be performed after any of the operations described with respect to FIG. 6C.

Although the operations have been depicted at particular points in time, the sequence of operations may occur at different points in time. For example, each of the operations 672a, 673a, 674a, and 676a may occur before and/or after any of the operations 672b, 673b, 674b, 676b, 672c, 673c, 674c, 676c, and/or each of the operations 672b, 673b, 674b, and 676b may occur before and/or after any of the operations 672a, 673a, 674a, 676a, 672c, 673c, 674c, 676c, and/or each of the operations 672c, 673c, 674c, and 676c may occur before and/or after any of the operations 672a, 673a, 674a, 676a, 672b, 673b, 674b, 676b.

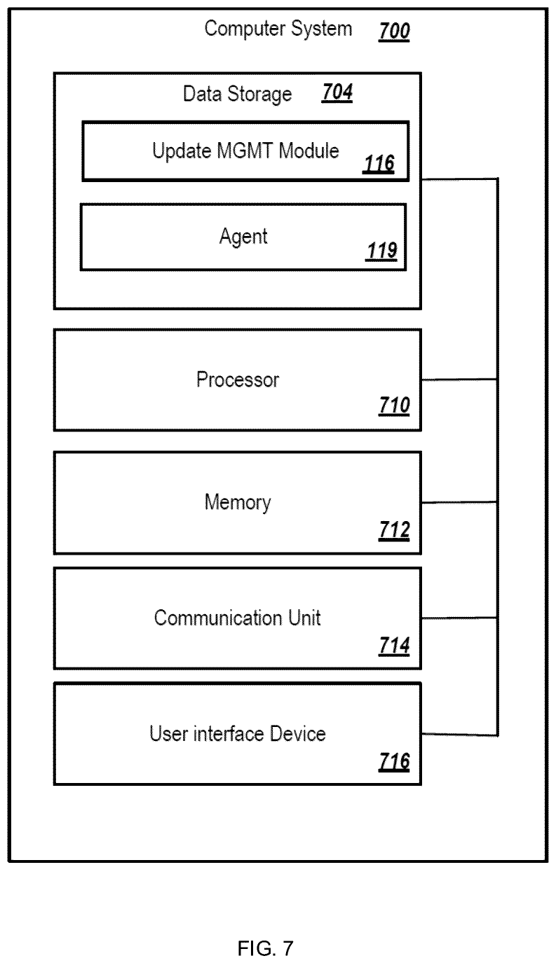

FIG. 7 illustrates an example computer system 700 configured for aggregated software update ring deployment, according to at least one example of the present disclosure. The computer system 700 may be implemented in the operating environment 100 FIG. 1, for instance. Examples of the computer system 700 may include the management device 102, one or more of the endpoints 106, the third-party server 104, the support device 113, the distribution server 112, or some combination thereof. The computer system 700 may include one or more processors 710, a memory 712, a communication unit 714, a user interface device 716, and a data storage 704 that includes the update management module 116 and the agent 119 (collectively, modules 116/119).

The processor 710 may include any suitable special-purpose or general-purpose computer, computing entity, or processing device including various computer hardware or software modules and may be configured to execute instructions stored on any applicable computer-readable storage media. For example, the processor 710 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 7, the processor 710 may more generally include any number of processors configured to perform individually or collectively any number of operations described in the present disclosure. Additionally, one or more of the processors 710 may be present on one or more different electronic devices or computing systems. In some examples, the processor 710 may interpret and/or execute program instructions and/or process data stored in the memory 712, the data storage 704, or the memory 712 and the data storage 704. In some examples, the processor 710 may fetch program instructions from the data storage 704 and load the program instructions in the memory 712. After the program instructions are loaded into the memory 712, the processor 710 may execute the program instructions.

The memory 712 and the data storage 704 may include computer-readable storage media for carrying or having computer-executable instructions or data structures stored thereon. Such computer-readable storage media may include any available media that may be accessed by a general-purpose or special-purpose computer, such as the processor 710. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 710 to perform a certain operation or group of operations.

The communication unit 714 may include one or more pieces of hardware configured to receive and send communications. In some examples, the communication unit 714 may include one or more of an antenna, a wired port, and modulation/demodulation hardware, among other communication hardware devices. In particular, the communication unit 714 may be configured to receive a communication from outside the computer system 700 and to present the communication to the processor 710 or to send a communication from the processor 710 to another device or network (e.g., the network 120 of FIG. 1).

The user interface device 716 may include one or more pieces of hardware configured to receive input from and/or provide output to a user. In some examples, the user interface device 716 may include one or more of a speaker, a microphone, a display, a keyboard, a touch screen, or a holographic projection, among other hardware devices.

The modules 116/119 may include program instructions stored in the data storage 704. The processor 710 may be configured to load the modules 116/119 into the memory 712 and execute the modules 116/119. Alternatively, the processor 710 may execute the modules 116/119 line-by-line from the data storage 704 without loading them into the memory 712. When executing the modules 116/119, the processor 710 may be configured to perform one or more processes or operations described elsewhere in this disclosure.

Modifications, additions, or omissions may be made to the computer system 700 without departing from the scope of the present disclosure. For example, in some examples, the computer system 700 may not include the user interface device 716. In some examples, the different components of the computer system 700 may be physically separate and may be communicatively coupled via any suitable mechanism. For example, the data storage 704 may be part of a storage device that is separate from a device, which includes the processor 710, the memory 712, and the communication unit 714, that is communicatively coupled to the storage device. The examples described herein may include the use of a special-purpose or general-purpose computer including various computer hardware or software modules, as discussed in greater detail below.

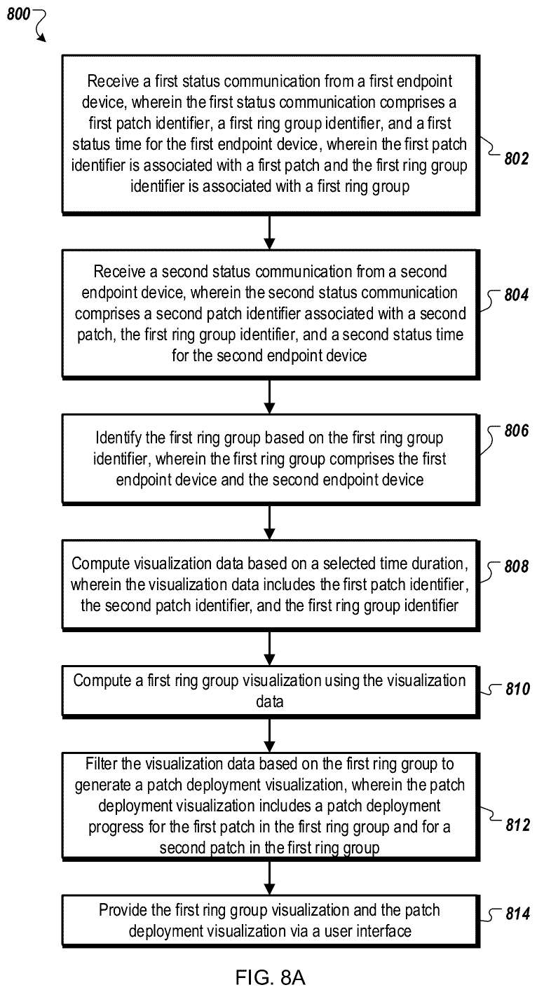

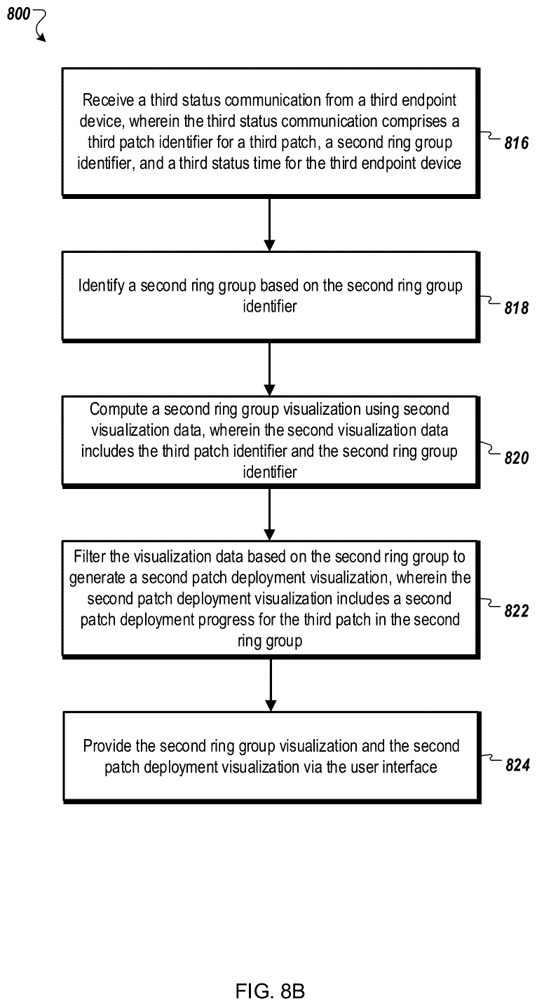

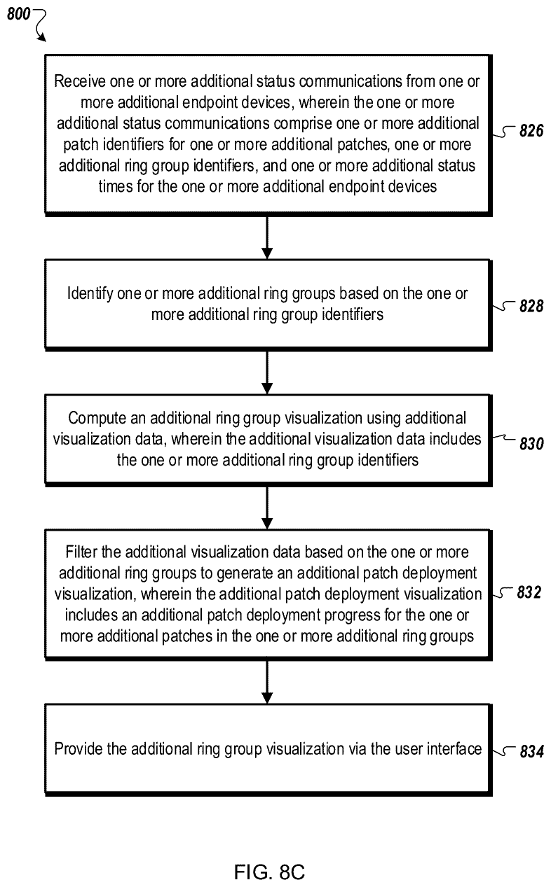

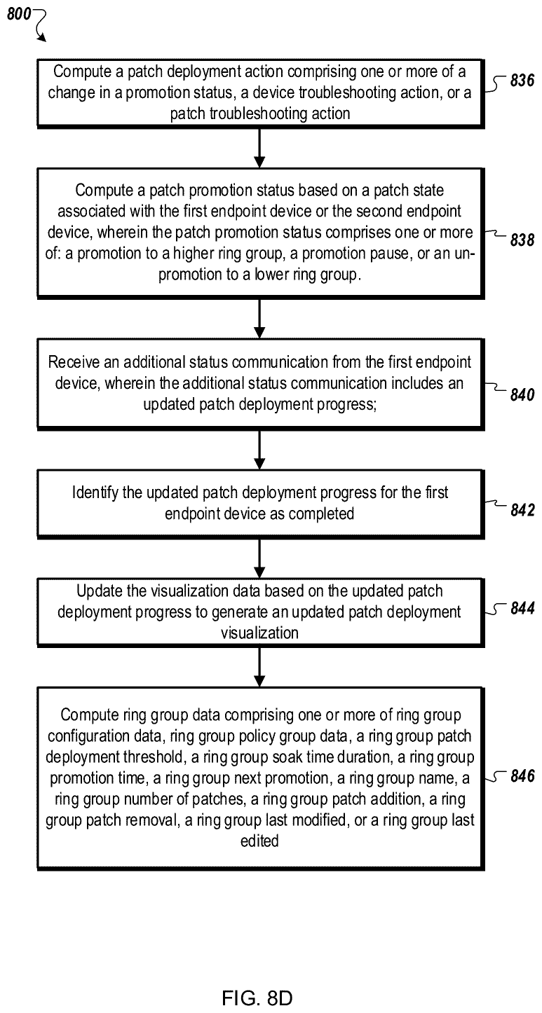

FIGS. 8A-8D are a flow chart of an example method 800 of an example aggregated software update ring deployment process, according to at least one example of the present disclosure. As described elsewhere in the present disclosure, the method 800 may involve or may be based on ring group visualization and patch deployment visualization. The method 800 may be performed in a suitable operating environment such as the operating environment 100 or the managed network 110 of FIG. 1. The method 800 may be performed by the management device 102 described elsewhere in the present disclosure or by another suitable computing system, such as the computer system 700 of FIG. 7. In some examples, the management device 102 or the other computing system may include or may be communicatively coupled to a non-transitory computer-readable medium (e.g., the memory 712 of FIG. 7) having stored thereon programming code or instructions that are executable by one or more processors (such as the processor 710 of FIG. 7) to cause a computing system or the management device 102 to perform or control performance of the method 800. Additionally or alternatively, the management device 102 may include the processor 710 that is configured to execute computer instructions to cause the management device 102 or another computing system to perform or control performance of the method 800. The management device 102 or the computer system 700 implementing the method 800 may be included in a cloud-based managed network, an on-premises system, or another suitable network computing environment. Although illustrated as discrete blocks, one or more blocks in FIGS. 8A-8D may be divided into additional blocks, combined into fewer blocks, or eliminated, depending on the desired implementation.

Referring to FIG. 8A, the method 800 may begin at block 802, in which a first status communication may be received from a first endpoint device. The first status communication may include a first patch identifier and a first status time for the first endpoint device. The first patch identifier may be associated with a first patch.

At block 804, a second status communication may be received from a second endpoint device. The second status communication may include a second patch identifier associated with a second patch and a second status time for the second endpoint device. In some embodiments, one or more of the first status communication or the second status communication further may include one or more of a device name, a patch installation progress, a patch deployment start time, a patch deployment elapsed time, a patch state, or a patch result. Alternatively or in addition, one or more of the first status communication or the second status communication may include one or more of a patch name, a patch severity, a VRR group, a patch installation progress, a patch first installation date, a patch soak duration, a patch status, or some combination thereof.

At block 806, the first ring group may be identified based on a first ring group identifier. The first ring group may include the first endpoint device and the second endpoint device. At block 808, visualization data based on a selected time duration may be computed. The visualization data may include the first patch identifier, the second patch identifier, and the first ring group identifier. At block 810, a first ring group visualization may be computed using the visualization data.

At block 812, the visualization data may be filtered based on the first ring group to generate a patch deployment visualization. The patch deployment visualization may include a patch deployment progress for the first patch in the first ring group and for a second patch in the first ring group. At block 814, the first ring group visualization and the patch deployment visualization may be provided via a user interface.

Referring to FIG. 8B, at block 816, a third status communication may be received from a third endpoint device. The third status communication may include a third patch identifier for a third patch and a third status time for the third endpoint device. At block 818, a second ring group may be identified based on a second ring group identifier. At block 820, a second ring group visualization may be computed using second visualization data. The second visualization data may include the third patch identifier and the second ring group identifier.

At block 822, the visualization data may be filtered based on the second ring group to generate a second patch deployment visualization. The second patch deployment visualization may include a second patch deployment progress for the third patch in the second ring group. At block 824, the second ring group visualization and the second patch deployment visualization may be provided via the user interface.

Referring to FIG. 8C, at block 826, one or more additional status communications may be received from one or more additional endpoint devices. The one or more additional status communications may include one or more additional patch identifiers for one or more additional patches and one or more additional status times for the one or more additional endpoint devices. At block 828, one or more additional ring groups may be identified based on the one or more additional ring group identifiers. At block 830, an additional ring group visualization may be computed using additional visualization data. The additional visualization data may include the one or more additional ring group identifiers.

At block 832, the additional visualization data may be filtered based on the one or more additional ring groups to generate an additional patch deployment visualization. The additional patch deployment visualization may include an additional patch deployment progress for the one or more additional patches in the one or more additional ring groups.

At block 834, the additional ring group visualization may be provided via the user interface. In one example, a patch deployment visualization may be filtered based on input from the user interface in which the user interface is on a remote device.

Referring to FIG. 8D, at block 836, a patch deployment action may be computed. The patch deployment action may include one or more of a change in a promotion status, a device troubleshooting action, or a patch troubleshooting action. At block 838, a patch promotion status may be computed based on a patch state associated with the first endpoint device or the second endpoint device. The patch promotion status may include one or more of: a promotion to a higher ring group, a promotion pause, or an un-promotion to a lower ring group. At block 840, an additional status communication may be received. The additional status communication may include an updated patch deployment progress. At block 842, the updated patch deployment progress for the first endpoint device may be identified as completed. At block 844, the visualization data may be updated based on the updated patch deployment progress to generate an updated patch deployment visualization.

At block 846, ring group data may be computed. The ring group data may include one or more of ring group configuration data, ring group policy group data, a ring group patch deployment threshold, a ring group soak time duration, a ring group promotion time, a ring group next promotion, a ring group name, a ring group number of patches, a ring group patch addition, a ring group patch removal, a ring group last modified, or a ring group last edited.

In these and other examples the method 800 may proceed through one or more of blocks 802, 804, 806, 808, 810, 812, 814, 816, 818, 820, 822, 824, 826, 828, 830, 832, 834, 836, 838, 840, 842, 844, 846, 848 or combinations thereof.

Further, modifications, additions, or omissions may be made to the method 800 without departing from the scope of the present disclosure. For example, the operations of method 800 may be implemented in differing order. Furthermore, the outlined operations and actions are only provided as examples, and some of the operations and actions may be optional, combined into fewer operations and actions, or expanded into additional operations and actions without detracting from the disclosed examples.

The examples described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some examples, the different components, modules, engines, and services described herein may be implemented as objects or processes that execute on the computing system (e.g., as separate threads). While some of the systems and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe examples of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although examples of the present inventions have been described in detail, it should be understood that the various changes, substitutions, and alterations could be made hereto without departing from the scope of the invention.

What is claimed is:

1. A method of automated software management, the method comprising:
receiving a first status communication from a first endpoint device, wherein the first status communication comprises a first patch identifier and a first status time for the first endpoint device, wherein the first patch identifier is associated with a first patch;
receiving a second status communication from a second endpoint device, wherein the second status communication comprises a second patch identifier associated with a second patch and a second status time for the second endpoint device;
identifying a first ring group based on a first ring group identifier, wherein the first ring group comprises the first endpoint device and the second endpoint device;
computing visualization data based on a selected time duration, wherein the visualization data includes the first patch identifier, the second patch identifier, and the first ring group identifier;
computing a first ring group visualization using the visualization data;
filtering the visualization data based on the first ring group to generate a patch deployment visualization, wherein the patch deployment visualization includes a patch deployment progress for the first patch in the first ring group and for a second patch in the first ring group; and
providing the first ring group visualization and the patch deployment visualization via a user interface.

2. The method of claim 1, further comprising:
receiving a third status communication from a third endpoint device, wherein the third status communication comprises a third patch identifier for a third patch and a third status time for the third endpoint device;
identifying a second ring group based on a second ring group identifier;
computing a second ring group visualization using second visualization data, wherein the second visualization data include the third patch identifier and the second ring group identifier;
filtering the visualization data based on the second ring group to generate a second patch deployment visualization, wherein the second patch deployment visualization includes a second patch deployment progress for the third patch in the second ring group; and
providing the second ring group visualization and the second patch deployment visualization via the user interface.

3. The method of claim 2, further comprising:
receiving one or more additional status communications from one or more additional endpoint devices, wherein the one or more additional status communications comprise one or more additional patch identifiers for one or more additional patches and one or more additional status times for the one or more additional endpoint devices; and
identifying one or more additional ring groups based on one or more additional ring group identifiers;
computing an additional ring group visualization using additional visualization data, wherein the additional visualization data includes the one or more additional ring group identifiers; and
filtering the additional visualization data based on the one or more additional ring groups to generate an additional patch deployment visualization, wherein the additional patch deployment visualization includes an additional patch deployment progress for the one or more additional patches in the one or more additional ring groups; and
providing the additional ring group visualization via the user interface.

4. The method of claim 1, further comprising computing a patch deployment action comprising one or more of a change in a promotion status, a device troubleshooting action, or a patch troubleshooting action.

5. The method of claim 1, further comprising:
computing a patch promotion status based on a patch state associated with the first endpoint device or the second endpoint device,
wherein the patch promotion status comprises one or more of: a promotion to a higher ring group, a promotion pause, or an un-promotion to a lower ring group.

6. The method of claim 1, further comprising:
receiving an additional status communication from the first endpoint device, wherein the additional status communication includes an updated patch deployment progress;
identifying the updated patch deployment progress for the first endpoint device as completed; and
updating the visualization data based on the updated patch deployment progress to generate an updated patch deployment visualization.

7. The method of claim 1, further comprising computing ring group data comprising one or more of ring group configuration data, ring group policy group data, a ring group patch deployment threshold, a ring group soak time duration, a ring group promotion time, a ring group next promotion, a ring group name, a ring group number of patches, a ring group patch addition, a ring group patch removal, a ring group last modified, or a ring group last edited.

8. The method of claim 1, wherein the patch deployment visualization is filtered based on input from the user interface, wherein the user interface is on a remote device.

9. The method of claim 1, wherein the one or more of the first status communication or the second status communication further comprises one or more of a device name, a patch installation progress, a patch deployment start time, a patch deployment elapsed time, a patch state, or a patch result.

10. The method of claim 1, wherein the one or more of the first status communication or the second status communication further comprises one or more of a patch name, a patch severity, a vulnerability risk rating (VRR) group, a patch installation progress, a patch first installation date, a patch soak duration, or a patch status.

11. One or more non-transitory computer-readable media having encoded thereon programming code executable by one or more processors to perform or control performance of operations to automate software management of a managed endpoint, the operations comprising:
receiving a first status communication from a first endpoint device, wherein the first status communication comprises a first patch identifier and a first status time for the first endpoint device, wherein the first patch identifier is associated with a first patch;
receiving a second status communication from a second endpoint device, wherein the second status communication comprises a second patch identifier associated with a second patch and a second status time for the second endpoint device;
identifying a first ring group based on a first ring group identifier, wherein the first ring group comprises the first endpoint device and the second endpoint device;
computing visualization data based on a selected time duration, wherein the visualization data includes the first patch identifier, the second patch identifier, and the first ring group identifier;
computing a first ring group visualization using the visualization data;
filtering the visualization data based on the first ring group to generate a patch deployment visualization, wherein the patch deployment visualization includes a patch deployment progress for the first patch in the first ring group and for a second patch in the first ring group; and
providing the first ring group visualization and the patch deployment visualization via a user interface.

12. The one or more non-transitory computer-readable media of claim 11, wherein the operations further comprise:
receiving a third status communication from a third endpoint device, wherein the third status communication comprises a third patch identifier for a third patch and a third status time for the third endpoint device;
identifying a second ring group based on a second ring group identifier;
computing a second ring group visualization using second visualization data, wherein the second visualization data include the third patch identifier and the second ring group identifier;
filtering the visualization data based on the second ring group to generate a second patch deployment visualization, wherein the second patch deployment visualization includes a second patch deployment progress for the third patch in the second ring group; and
providing the second ring group visualization and the second patch deployment visualization via the user interface.

13. The one or more non-transitory computer-readable media of claim 12, further comprising:
receiving one or more additional status communications from one or more additional endpoint devices, wherein the one or more additional status communications comprise one or more additional patch identifiers for one or more additional patches and one or more additional status times for the one or more additional endpoint devices; and
identifying one or more additional ring groups based on one or more additional ring group identifiers;
computing an additional ring group visualization using additional visualization data, wherein the additional visualization data includes the one or more additional ring group identifiers; and
filtering the additional visualization data based on the one or more additional ring groups to generate an additional patch deployment visualization, wherein the additional patch deployment visualization includes an additional patch deployment progress for the one or more additional patches in the one or more additional ring groups; and
providing the additional ring group visualization via the user interface.

14. The one or more non-transitory computer-readable media of claim 11, wherein the operations further comprise:
computing a patch deployment action comprising one or more of a change in a promotion status, a device troubleshooting action, or a patch troubleshooting action.

15. The one or more non-transitory computer-readable media of claim 11, wherein the operations further comprise:
computing a patch promotion status based on a patch state associated with the first endpoint device or the second endpoint device,
wherein the patch promotion status comprises one or more of: a promotion to a higher ring group, a promotion pause, or an un-promotion to a lower ring group.

16. The one or more non-transitory computer-readable media of claim 11, wherein the operations further comprise:
receiving an additional status communication from the first endpoint device, wherein the additional status communication includes an updated patch deployment progress;
identifying the updated patch deployment progress for the first endpoint device as completed; and
updating the visualization data based on the updated patch deployment progress to generate an updated patch deployment visualization.

17. The one or more non-transitory computer-readable media of claim 11, wherein the operations further comprise:
computing ring group data comprising one or more of ring group configuration data, ring group policy group data, a ring group patch deployment threshold, a ring group soak time duration, a ring group promotion time, a ring group next promotion, a ring group name, a ring group number of patches, a ring group patch addition, a ring group patch removal, a ring group last modified, or a ring group last edited.

18. The one or more non-transitory computer-readable media of claim 11, wherein the patch deployment visualization is filtered based on input from the user interface, wherein the user interface is on a remote device.

19. The one or more non-transitory computer-readable media of claim 11, wherein the one or more of the first status communication or the second status communication further comprises one or more of a device name, a patch installation progress, a patch deployment start time, a patch deployment elapsed time, a patch state, or a patch result.

20. The one or more non-transitory computer-readable media of claim 11, wherein the one or more of the first status communication or the second status communication further comprises one or more of a patch name, a patch severity, a vulnerability risk rating (VRR) group, a patch installation progress, a patch first installation date, a patch soak duration, or a patch status.
